(19) United States
(12) Patent Application Publication
(10) Pub. No.: US 2012/0019848 A1
(43) Pub. Date: Jan. 26, 2012

(54) PRINT SYSTEM, PRINTING DEVICE AND COMMUNICATION TERMINAL

(75) Inventor: Atsushi Uemura, Osaka (JP)

(73) Assignee: Sharp Kabushiki Kaisha, Osaka-shi (JP)

(21) Appl. No.: 13/187,866

(22) Filed: Jul. 21, 2011

(30) Foreign Application Priority Data
Jul. 22, 2010 (JP) 2010-164732

(51) Int. Cl. G06K 15/02

(52) U.S. Cl. 358/1.9

(57) ABSTRACT

When a request for acquiring image correction data is issued, as is periodically done by a communication terminal, a printing device transmits the image correction data, if the state of the printing device is in a normal mode or in a first energy saving mode. If the acquisition of the image correction data as is periodically done by the communication terminal fails, the printing device transmits the image correction data to the communication terminal at the time when the communication terminal creates print data.

### CROSS-REFERENCE TO RELATED APPLICATION

This nonprovisional application claims priority under 35 U.S.C. §119(a) on Patent Application No. 2010-164732 filed in Japan on Jul. 22, 2010, the entire contents of which are hereby incorporated by reference.

### BACKGROUND OF THE INVENTION

1. Field of the Invention

The present invention relates to a print system including a printing device and a communication terminal and, more specifically, to a technique for transmitting/receiving image correction data.

2. Description of the Background Art

Conventionally, a print system including a PC (Personal Computer) having a printer driver installed therein and a printer for forming an image based on image data transmitted from the PC has been known. In such a print system, a technique of executing image correction and pixel binarization on the image data on the PC side, in order to reduce load on the printer, has been known. If such a technique is used, the printer creates image correction data for adjusting image density or the like by a calibration process, and the PC performs the image correction process using the created image correction data.

An electro-photography type printer forms an image utilizing electrostatic force. From this reason of operating principle, in the printer, characteristics of image forming engine are liable to variation dependent on change is surrounding environment such as temperature and use history (usable life). Therefore, the image correction data created by the printer change over time. In order to constantly form images of good quality, it is necessary for the PC to acquire image correction data that corresponds to the latest state of the printer.

One method for the PC to acquire the image correction data corresponding to the latest state of the printer is to acquire the image correction data immediately before creating print data. If this method is used, however, start of printing would be delayed, since it takes time to acquire the image correction data.

Another method for the PC to acquire the image correction data corresponding to the latest state of the printer is to acquire the image correction data on a periodic basis. Using this method, with the interval for acquiring the image correction data set shorter than the interval for executing calibration, which takes place periodically on the printer side, it becomes possible for the PC to acquire the latest image correction data.

Recently, devices having an energy saving mode for reducing power consumption of the device body (hereinafter simply referred to as “energy saving mode”) have come to be widely used. By way of example, Japanese Patent No. 4372109 (hereinafter referred to as '109 Reference) discloses an image processing apparatus that supplies power to minimal necessary functional blocks at appropriate timing, in accordance with the state of the apparatus itself and on contents of a request received from an external device through NIC (Network Interface Card), when the apparatus is in a sleep mode (power saving state).

Japanese Patent Laying-Open No. 2009-199189 (hereinafter referred to as '189 Reference) discloses an image forming apparatus that makes a transition to an HDD access mode in which minimal necessary functions only are activated for operation, without activating a main CPU, when an access request to the HDD is received in the energy saving mode.

Japanese Patent Laying-Open No. 2008-41052 (hereinafter referred to as '052 Reference) discloses network equipment. When a return bit pattern input transmitted from a controller is received in a power saving state, the equipment returns from the power saving state to the normal power state, and when a confirmation bit pattern input transmitted periodically from the controller is received, the equipment remains in the power saving state and returns a response that it is in the power saving state, to the controller.

In a printer having the functions disclosed in '109, '189 and '052 References, when a request for acquiring the image correction data is received in a state in which transmission of image correction data is impossible, that is, in the energy saving mode, it becomes necessary to cancel the energy saving mode, to transmit the image correction data. Assuming that the PC acquires the image correction data periodically, it follows that the energy saving mode is canceled every time the acquisition takes place. This leads to wasteful power consumption of considerable amount.

### SUMMARY OF THE INVENTION

In view of the problems described above, it is desirable to provide a print system that can reduce power consumption and allows acquisition of image correction data corresponding to the latest state of the printing device.

According to a first aspect, the present invention provides a print system, including a communication terminal performing an image correction process based on image correction data to create print data, and a printing device performing a printing process based on the print data. The communication terminal includes: an inquiry unit inquiring the printing device whether or not acquisition of the image correction data is possible, at every predetermined prescribed time interval; a first data receiving unit receiving, if a result of determination to the inquiry indicates that acquisition of the image correction data is possible, the image correction data transmitted from the printing device; a first setting unit setting a state of acquisition of the image correction data to a state representing a success, in response to the first data receiving unit receiving the image correction data; an instruction receiving unit receiving an instruction requesting creation of the print data; an acquisition state determining unit determining whether the state of acquisition of the image correction data represents a success, in response to the instruction receiving unit receiving the instruction; a first requesting unit requesting, if it is determined by the acquisition state determining unit that the state of acquisition of the image correction data does not represent a success, the printing device to transmit the image correction data; and a second data receiving unit receiving, in response to the request by the first requesting unit, the image correction data transmitted from the printing device. The printing device includes: an inquiry receiving unit receiving the inquiry made by the inquiry unit; a first determining unit determining whether or not the state of the printing device allows transmission of the image correction data to the communication terminal, in response to the inquiry receiving unit receiving the inquiry; a first data transmitting unit transmitting, if it is determined by the first determining unit that the state of the printing device allows transmission of the image correction data to the communication terminal, the image correction data to the communication terminal; a first request receiving unit receiving the request from the first requesting unit; a second determining unit determining whether or not the state of the printing device allows transmission of the image correction data to the communication terminal, in response to the first request receiving unit receiving the request; a transition unit causing, if it is determined by the second determining unit that the state of the printing device does not allow transmission of the image correction data to the communication terminal, a state transition of the printing device to a state allowing transmission of the image correction data; and a second data transmitting unit transmitting, if it is determined by the second determining unit that the state of the printing device allows transmission of the image correction data to the communication terminal, or if the state transition has been done by the transition unit, the image correction data to the communication terminal.

As described above, when a request for acquiring the image correction data is issued, as is periodically done by the communication terminal, the printing device transmits the image correction data, if the state of the printing device allows transmission of image correction data to the communication terminal. Therefore, it becomes unnecessary to make a transition or cancellation of the state for transmitting the image correction data. As a result, as compared with the case in which the image correction data is transmitted in any state, power consumption can be reduced.

If acquisition of the image correction data periodically done by the communication terminal is in a failed state, the printing device transmits the image correction data to the communication terminal when the communication terminal creates the print data. Here, if the state of printing device does not allow transmission of the image correction data to the communication terminal, a state transition of the printing device is made, to the state allowing transmission of the image correction data, and thereafter, the image correction data is transmitted. As a result, it becomes always possible for the communication terminal to create the print data based on the image correction data corresponding to the latest state of the printing device.

According to the second aspect, the present invention provides a print system, including a communication terminal performing an image correction process based on image correction data to create print data, and a printing device performing a printing process based on the print data. The communication terminal includes: an inquiry unit inquiring the printing device whether or not acquisition of the image correction data is possible, at every predetermined prescribed time interval; a first data receiving unit receiving, if a result of determination to the inquiry indicates that acquisition of the image correction data is possible, the image correction data transmitted from the printing device; a first setting unit setting a state of acquisition of the image correction data to a state representing a success, in response to the first data receiving unit receiving the image correction data; an instruction receiving unit receiving an instruction requesting creation of the print data; an acquisition state determining unit determining whether the state of acquisition of the image correction data represents a success, in response to the instruction receiving unit receiving the instruction; a commanding unit commanding the printing device to make a state transition to a state allowing transmission of the image correction data, if it is determined by the acquisition state determining unit that the state of acquisition of the image correction data does not represent a success; a first requesting unit requesting the printing device to transmit the image correction data after the command is given by the commanding unit; and a second data receiving unit receiving the image correction data transmitted from the printing device, in response to the request from the first requesting unit. The printing device includes: an inquiry receiving unit receiving the inquiry made by the inquiry unit; a first determining unit determining whether or not the state of the printing device allows transmission of the image correction data to the communication terminal, in response to the inquiry receiving unit receiving the inquiry; a first data transmitting unit transmitting, if it is determined by the first determining unit that the state of the printing device allows transmission of the image correction data to the communication terminal, the image correction data to the communication terminal; a command receiving unit receiving the command from the commanding unit; a second determining unit determining whether or not the state of the printing device allows transmission of the image correction data to the communication terminal, in response to the command receiving unit receiving the command; a transition unit, causing a state transition of the printing device to a state allowing transmission of the image correcting data, if it is determined by the second determining unit that the state of the printing device does not allow transmission of the image correction data to the communication terminal; a first request receiving unit receiving the request from the first requesting unit; and a second data transmitting unit transmitting the image correction data to the communication terminal, in response to the first request receiving unit receiving the request.

As described above, when a request for acquiring the image correction data is issued, as is periodically done by the communication terminal, the printing device transmits the image correction data, if the state of the printing device allows transmission of image correction data to the communication terminal. Therefore, it becomes unnecessary to make a transition or cancellation of the state for transmitting the image correction data. As a result, as compared with the case in which the image correction data is transmitted in any state, power consumption can be reduced.

If acquisition of the image correction data periodically done by the communication terminal is in a failed state, the printing device transmits the image correction data to the communication terminal when the communication terminal creates the print data. Here, if the state of printing device does not allow transmission of the image correction data to the communication terminal, before transmission of the image correction data, a state transition of the printing device is made, to the state allowing transmission of the image correction data. As a result, it becomes always possible for the communication terminal to create the print data based on the image correction data corresponding to the latest state of the printing device.

Preferably, the communication terminal further includes a determination result receiving unit receiving a result of determination to the inquiry transmitted from the printing device, and a second requesting unit requesting, if the result of determination to the inquiry received by the determination result receiving unit indicates that acquisition of the image correction data is possible, the printing device to transmit the image correction data. The printing device further includes a first result transmitting unit transmitting, if it is determined by the first determining unit that the state of the printing device allows transmission of the image correction data to the communication terminal, a piece of information indicating that acquisition of the image correction data is possible, as a result of determination to the inquiry, to the communication terminal, and a second request receiving unit receiving the request from the second requesting unit. The first data transmitting unit transmits, in response to the second request receiving unit receiving the request, the image correction data to the communication terminal.

Therefore, it becomes possible for the communication terminal to more reliably obtain the result of determination as to whether the image correction data can be acquired. Thus, power consumption can more reliably be reduced.

More preferably, the communication terminal further includes a second setting unit setting the state of acquisition of the image correction data to a state representing a failure, if the result of determination to the inquiry received by the determination result receiving unit indicates that acquisition of the image correction data is impossible. The printing device further includes a second result transmitting unit transmitting, if it is determined by the first determining unit that the state of the printing device does not allow transmission of the image correction data to the communication terminal, a piece of information indicating that acquisition of the image correction data is impossible, as a result of determination to the inquiry, to the communication terminal.

Therefore, it becomes possible to more accurately determine whether or not the state of acquisition of the image correction data represents a success. As a result, the communication terminal can more reliably acquire the image correction data corresponding to the latest state of the printing device.

According to a third aspect, the present invention provides a print system, including a communication terminal performing an image correction process based on image correction data to create print data, and a printing device performing a printing process based on the print data. The communication terminal includes: a first requesting unit requesting the printing device to transmit the image correction data, at every predetermined prescribed time interval; a first data receiving unit receiving the image correction data transmitted from the printing device in response to the request by the first requesting unit; an analysis determining unit analyzing the image correction data received by the first data receiving unit and, based on a result of analysis, determining whether or not the image correction data is valid; a first setting unit setting a state of acquisition of the image correction data to a state representing a success, if it is determined by the analysis determining unit that the image correction data is valid; an instruction receiving unit receiving an instruction requesting creation of the print data; an acquisition state determining unit determining whether or not the state of acquisition of the image correction data represents a success, in response to the instruction receiving unit receiving the instruction; a commanding unit commanding the printing device to make a state transition to a state allowing transmission of the image correction data, if it is determined by the acquisition state determining unit that the state of acquisition of the image correction data does not represent a success; a second requesting unit requesting, after the command is given from the commanding unit, the printing device to transmit the image correction data; and a second data receiving unit receiving the image correction data transmitted from the printing device in response to the request from the second requesting unit. The printing device includes: a first request receiving unit receiving the request from the first requesting unit; a first determining unit determining whether the state of the printing device allows transmission of the image correction data to the communication terminal, in response to the first request receiving unit receiving the request; a first data transmitting unit transmitting valid image correction data to the communication terminal, if it is determined by the first determining unit that the state of the printing device allows transmission of the image correction data to the communication terminal; a command receiving unit receiving the command from the commanding unit; a second determining unit determining whether or not the state of the printing device allows transmission of the image correction data to the communication terminal, in response to the command receiving unit receiving the command; a transition unit, causing a state transition of the printing device to a state allowing transmission of the image correcting data, if it is determined by the second determining unit that the state of the printing device does not allow transmission of the image correction data to the communication terminal; a second request receiving unit receiving the request from the second requesting unit; and a second data transmitting unit transmitting the image correction data to the communication terminal, in response to the second request receiving unit receiving the request.

As described above, when a request for acquiring the image correction data is issued, as is periodically done by the communication terminal, the printing device transmits valid image correction data, if the state of the printing device allows transmission of the image correction data to the communication terminal. Therefore, it becomes unnecessary to make a transition or cancellation of the state for transmitting the image correction data. As a result, as compared with the case in which the image correction data is transmitted in any state, power consumption can be reduced.

If acquisition of the image correction data periodically done by the communication terminal is in a failed state, the printing device transmits the image correction data to the communication terminal when the communication terminal creates the print data. Here, if the state of printing device does not allow transmission of the image correction data to the communication terminal, before transmission of the image correction data, a state transition of the printing device is made, to the state allowing transmission of the image correction data. As a result, it becomes always possible for the communication terminal to create the print data based on the image correction data corresponding to the latest state of the printing device.

Preferably, the printing device further includes a third data transmitting unit transmitting invalid image correction data to the communication terminal, if it is determined by the first determining unit that the state of the printing device does not allow transmission of the image correction data to the communication terminal. The communication terminal further includes a second setting unit setting the state of acquisition of the image correction data to a state representing a failure, if it is determined by the analysis determining unit that the image correction data is not valid.

Therefore, it becomes possible to more accurately determine whether or not the state of acquisition of the image correction data represents a success. As a result, the communication terminal can more reliably acquire the image correction data corresponding to the latest state of the printing device.

More preferably, the state allowing transmission of the image correction data to the communication terminal refers to a state in which electric power is supplied to a main controller executing a process for transmitting the image correction data; and the state not allowing transmission of the image correction data to the communication terminal refers to a state in which electric power is not supplied to the main controller. Thus, the power consumption can further be reduced.

According to a fourth aspect, the present invention provides a communication terminal used in a print system including the communication terminal performing an image correction process based on image correction data to create print data, and a printing device performing a printing process based on the print data. The communication terminal includes: an inquiry unit inquiring the printing device whether or not acquisition of the image correction data is possible, at every predetermined prescribed time interval; a first data receiving unit receiving, if a result of determination to the inquiry transmitted from the printing device indicates that acquisition of the image correction data is possible, the image correction data transmitted from the printing device; a first setting unit setting a state of acquisition of the image correction data to a state representing a success, in response to the first data receiving unit receiving the image correction data; an instruction receiving unit receiving an instruction requesting creation of the print data; an acquisition state determining unit determining whether the state of acquisition of the image correction data represents a success, in response to the instruction receiving unit receiving the instruction; a first requesting unit requesting, if it is determined by the acquisition state determining unit that the state of acquisition of the image correction data does not represent a success, the printing device to transmit the image correction data and a second data receiving unit receiving, in response to the request by the first requesting unit, the image correction data transmitted from the printing device.

According to a fifth aspect, the present invention provides a printing device used in a print system including a communication terminal performing an image correction process based on image correction data to create print data and the printing device performing a printing process based on the print data. The printing device includes: an inquiry receiving unit receiving an inquiry as to whether acquisition of the image correction data is possible, transmitted from the communication terminal at every predetermined prescribed time interval; a first determining unit determining whether or not the state of the printing device allows transmission of the image correction data to the communication terminal, in response to the inquiry receiving unit receiving the inquiry; a first data transmitting unit transmitting, if it is determined by the first determining unit that the state of the printing device allows transmission of the image correction data to the communication terminal, the image correction data to the communication terminal; a first request receiving unit receiving a request for transmission of the image correction data, transmitted from the communication terminal; a second determining unit determining whether or not the state of the printing device allows transmission of the image correction data to the communication terminal, in response to the first request receiving unit receiving the request; a transition unit causing, if it is determined by the second determining unit that the state of the printing device does not allow transmission of the image correction data to the communication terminal, a state transition of the printing device to a state allowing transmission of the image correction data; and a second data transmitting unit transmitting, if it is determined by the second determining unit that the state of the printing device allows transmission of the image correction data to the communication terminal, or if the state transition has been done by the transition unit, the image correction data to the communication unit.

As described above, when a request for acquiring the image correction data is issued, as is periodically done by the communication terminal, the printing device transmits the image correction data, if the state of the printing device allows transmission of image correction data to the communication terminal. Therefore, it becomes unnecessary to make a transition or cancellation of the state for transmitting the image correction data. As a result, as compared with the case in which the image correction data is transmitted in any state, power consumption can be reduced.

If acquisition of the image correction data periodically done by the communication terminal is in a failed state, the printing device transmits the image correction data to the communication terminal when the communication terminal creates the print data. Here, if the state of printing device does not allow transmission of the image correction data to the communication terminal, a state transition of the printing device is made, to the state allowing transmission of the image correction data, and thereafter, the image correction data is transmitted. As a result, it becomes always possible for the communication terminal to create the print data based on the image correction data corresponding to the latest state of the printing device.

According to a sixth aspect, the present invention provides a communication terminal used in a print system including the communication terminal performing an image correction process based on image correction data to create print data, and a printing device performing a printing process based on the print data. The communication terminal includes: an inquiry unit inquiring the printing device whether or not acquisition of the image correction data is possible, at every predetermined prescribed time interval; a first data receiving unit receiving, if a result of determination to the inquiry transmitted from the printing device indicates that acquisition of the image correction data is possible, the image correction data transmitted from the printing device; a first setting unit setting a state of acquisition of the image correction data to a state representing a success, in response to the first data receiving unit receiving the image correction data; an instruction receiving unit receiving an instruction requesting creation of the print data; an acquisition state determining unit determining whether the state of acquisition of the image correction data represents a success, in response to the instruction receiving unit receiving the instruction; a commanding unit commanding the printing device to make a state transition to a state allowing transmission of the image correction data, if it is determined by the acquisition state determining unit that the state of acquisition of the image correction data does not represent a success; a first requesting unit requesting the printing device to transmit the image correction data after the command is given by the commanding unit; and a second data receiving unit receiving the image correction data transmitted from the printing device in response to the request from the first requesting unit.

According to a seventh aspect, the present invention provides a printing device used in a print system including a communication terminal performing an image correction process based on image correction data to create print data and the printing device performing a printing process based on the print data. The printing device includes: an inquiry receiving unit receiving an inquiry as to whether acquisition of the image correction data is possible, transmitted from the communication terminal at every predetermined prescribed time interval; a first determining unit determining whether or not the state of the printing device allows transmission of the image correction data to the communication terminal, in response to the inquiry receiving unit receiving the inquiry; a first data transmitting unit transmitting, if it is determined by the first determining unit that the state of the printing device allows transmission of the image correction data to the communication terminal, the image correction data to the communication terminal; a command receiving unit receiving a command to make a state transition of the printing device to a state allowing transmission of the image correction data, transmitted from the communication terminal; a second determining unit determining whether or not the state of the printing device allows transmission of the image correction data to the communication terminal, in response to the command receiving unit receiving the command; a transition unit causing a state transition of the printing device to the state allowing transmission of the image correction data, if it is determined by the second determining unit that the state of the printing device does not allow transmission of the image correction data to the communication terminal; a first request receiving unit receiving a request for transmission of the image correction data, transmitted from the communication terminal after the command is given; and a second data transmitting unit transmitting the image correction data to the communication terminal, in response to the first request receiving unit receiving the request.

As described above, when a request for acquiring the image correction data is issued, as is periodically done by the communication terminal, the printing device transmits the image correction data, if the state of the printing device allows transmission of image correction data to the communication terminal. Therefore, it becomes unnecessary to make a transition or cancellation of the state for transmitting the image correction data. As a result, as compared with the case in which the image correction data is transmitted in any state, power consumption can be reduced.

If acquisition of the image correction data periodically done by the communication terminal is in a failed state, the printing device transmits the image correction data to the communication terminal when the communication terminal creates the print data. Here, if the state of printing device does not allow transmission of the image correction data to the communication terminal, before transmission of the image correction data, a state transition of the printing device is made, to the state allowing transmission of the image correction data. As a result, it becomes always possible for the communication terminal to create the print data based on the image correction data corresponding to the latest state of the printing device.

According to an eighth aspect, the present invention provides a communication terminal used in a print system including the communication terminal performing an image correction process based on image correction data to create print data, and a printing device performing a printing process based on the print data. The communication terminal includes: a first requesting unit requesting the printing device to transmit the image correction data, at every predetermined prescribed time interval; a first data receiving unit receiving the image correction data transmitted from the printing device, in response to the request from the first requesting unit; an analysis determining unit analyzing the image correction data received by the first data receiving unit, and determining whether or not the image correction data is valid based on a result of analysis; a first setting unit setting a state of acquisition of the image correction data to a state representing a success, if it is determined by the analysis determining unit that the image correction data is valid; an instruction receiving unit receiving an instruction requesting creation of the print data; an acquisition state determining unit determining whether or not the state of acquisition of the image correction data represents a success, in response to the instruction receiving unit receiving the instruction; a commanding unit commanding the printing device to make a state transition to a state allowing transmission of the image correction data, if it is determined by the acquisition state determining unit that the state of acquisition of the image correction data does not represent a success; a second requesting unit requesting the printing device to transmit the image correction data after the command is given by the commanding unit; and a second data receiving unit receiving the image correction data transmitted from the printing device in response to the request from the second requesting unit.

According to a ninth aspect, the present invention provides a printing device used in a print system including a communication terminal performing an image correction process based on image correction data to create print data and the printing device performing a printing process based on the print data. The printing device includes: a first request receiving unit receiving a request for transmission of the image correction data transmitted from the communication terminal at every predetermined prescribed time interval; a first determining unit determining whether or not the state of the printing device allows transmission of the image correction data to the communication terminal, in response to the first request receiving unit receiving the request; a first data transmitting unit transmitting valid image correction data to the communication terminal, if it is determined by the first determining unit that the state of the printing device allows transmission of the image correction data; a command receiving unit receiving a command to make a state transition of the printing device to a state allowing transmission of the image correction data, transmitted from the communication terminal; a second determining unit determining whether or not the state of the printing device allows transmission of the image correction data to the communication terminal, in response to the command receiving unit receiving the command; a transition unit causing a state transition of the printing device to the state allowing transmission of the image correction data, if it is determined by the second determining unit that the state of the printing device does not allow transmission of the image correction data to the communication terminal; a second request receiving unit receiving a request for transmission of the image correction data, transmitted from the communication terminal after the command is given; and a second data transmitting unit transmitting the image correction data to the communication terminal, in response to the second request receiving unit receiving the request.

As described above, when a request for acquiring the image correction data is issued, as is periodically done by the communication terminal, the printing device transmits valid image correction data, if the state of the printing device allows transmission of the image correction data to the communication terminal. Therefore, it becomes unnecessary to make a transition or cancellation of the state for transmitting the image correction data. As a result, as compared with the case in which the image correction data is transmitted in any state, power consumption can be reduced.

If acquisition of the image correction data periodically done by the communication terminal is in a failed state, the printing device transmits the image correction data to the communication terminal when the communication terminal creates the print data. Here, if the state of printing device does not allow transmission of the image correction data to the communication terminal, before transmission of the image correction data, a state transition of the printing device is made, to the state allowing transmission of the image correction data. As a result, it becomes always possible for the communication terminal to create the print data based on the image correction data corresponding to the latest state of the printing device.

According to the present invention, when a request for acquiring the image correction data is issued, as is periodically done by the communication terminal, the printing device transmits the image correction data, if the state of the printing device allows transmission of image correction data to the communication terminal. Therefore, it becomes unnecessary to make a transition or cancellation of the state for transmitting the image correction data. As a result, as compared with the case in which the image correction data is transmitted in any state, power consumption can be reduced.

If acquisition of the image correction data periodically done by the communication terminal is in a failed state, the printing device transmits the image correction data to the communication terminal when the communication terminal creates the print data. As a result, it becomes always possible for the communication terminal to create the print data based on the image correction data corresponding to the latest state of the printing device.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows a configuration of a print system in accordance with a first embodiment of the present invention.

FIG. 2 is a block diagram showing a configuration of a printing device.

FIG. 3 is a block diagram showing a configuration of a communication terminal.

FIG. 4 is a functional block diagram of the printing device and the communication terminal.

FIG. 5 is a flowchart representing a control structure of a computer program for realizing an image correction data acquisition process in accordance with the first embodiment of the present invention.

FIG. 6 is a flowchart representing a control structure of a computer program for realizing a transmission process for transmitting transmission availability information in accordance with the first embodiment of the present invention.

FIG. 7 is a flowchart representing a control structure of a computer program realizing a print data creation process in accordance with the first embodiment of the present invention.

FIG. 8 is a flowchart representing a control structure of a computer program realizing an image correction data transmission process in accordance with the first embodiment of the present invention.

FIG. 9 is a flowchart representing a control structure of a computer program realizing a print process in accordance with the first embodiment of the present invention.

FIG. 10 is a flowchart representing a control structure of a computer program realizing a print data creation process in accordance with a second embodiment of the present invention.

FIG. 11 is a flowchart representing a control structure of a computer program realizing an image correction data transmission process in accordance with the second embodiment of the present invention.

FIG. 12 is a flowchart representing a control structure of a computer program realizing an image correction data acquisition process in accordance with a third embodiment of the present invention.

FIG. 13 is a flowchart representing a control structure of a computer program realizing an image correction data transmission process in accordance with the third embodiment of the present invention.

### DESCRIPTION OF THE PREFERRED EMBODIMENTS

In the following description, the same components are denoted by the same reference characters. Their names and functions are also the same. Therefore, detailed description thereof will not be repeated.

### First Embodiment

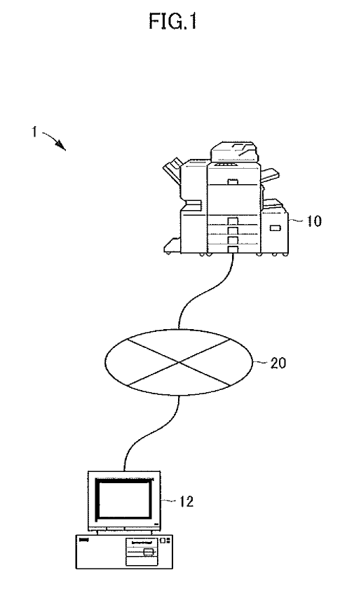

Referring to FIG. 1, a print system 1 in accordance with a first embodiment of the present invention includes a printing device 10 and a communication terminal 12. Printing device 10 and communication terminal 12 are connected to each other through a network 20 implemented, for example, by LAN (Local Area Network), and capable of transmitting/receiving various data to and from each other.

Printing device 10 is an MFP (Multifunction Printer) having scanner function, copy function, printer function and the like.

Communication terminal 12 is, for example, a terminal such as a PC, operated by a general user for using printing device 10. Though only one communication terminal 12 is shown in FIG. 1, actually, there may be a plurality of communication terminals.

In print system 1, when print data as the object of printing is transmitted from communication terminal 12 to printing device 10, printing device 10 executes a printing process for forming an image based on the print data.

### Hardware Configuration

### Printing Device 10

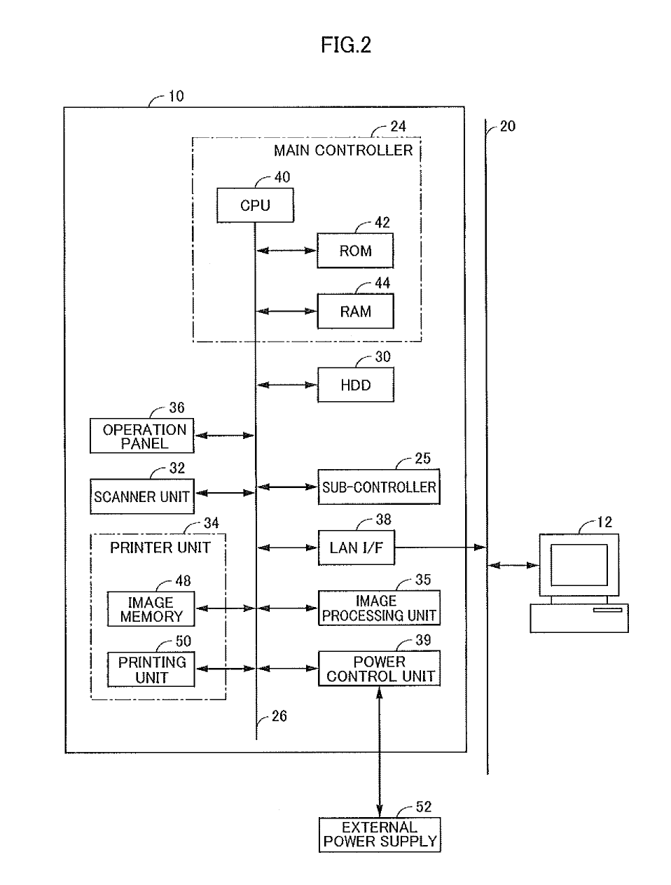

Referring to FIG. 2, printing device 10 includes a main controller 24, a sub-controller 25, an HDD 30, a scanner unit 32, a printer unit 34, an image processing unit 35, an operation panel 36, an LAN interface (LAN I/F) 38 and a power control unit 39.

Main controller 24 is substantially a computer, and it includes a CPU 40, an ROM 42 and an RAM 44. To CPU 40, a BUS line 26 is connected. To BUS line 26, ROM 42 and RAM 44 are electrically connected. CPU 40 executes various computer programs in accordance with instructions from operation panel 36 or the like, and thereby executes operations of various units and components of printing device 10 and desired processes such as communication with communication terminal 12. The various computer programs mentioned above are stored in advance in ROM 42 or HDD 30 and, at the time of execution of a desired process, read from ROM 42 or HDD 30 and transferred to RAM 44. CPU 40 reads and interprets a program instruction from an address in RAM 44 designated by a value stored in a register (not shown) referred to as a program counter, in CPU 40. CPU 40 reads data necessary for an operation from an address designated by the read instruction, and executes the operation corresponding to the instruction on the data. The result of execution is stored at the address designated by the instruction, in the register in CPU 40, HDD 30, RAM 44 and the like.

Sub-controller 25 is a computer controlling communication through LAN I/F 38. Sub-controller 25 includes a sub-CPU, a sub-ROM and a sub-RAM (all not shown). These sub-CPU, sub-ROM and sub-RAM are connected to BUS line 26. The sub-CPU, sub-ROM and sub-RAM operate in the similar manner as CPU 40, ROM 42 and RAM 44. Specifically, the sub-CPU executes various computer programs stored in the sub-ROM, and thereby executes desired processes such as communication with communication terminal 12.

The sub-ROM stores computer programs for realizing operations necessary to maintain connection to network 20 and, in addition, computer programs for realizing the transmission process for transmitting transmission availability information and the image correction data transmission process, as will be described later.

To BUS line 26, HDD 30, scanner unit 32, printer unit 34, image processing unit 35, operation panel 36, LAN I/F 38 and power control unit 39 are further electrically connected.

HDD 30 includes a magnetic recording medium. HDD 30 stores various data including image data, computer programs for realizing general operations of printing device 10, and computer programs for realizing the printing process as will be described later.

Scanner unit 32 includes a document scanning unit with a light source, a reflection mirror, an optical lens and a CCD (Charge Coupled Device) line sensor (all not shown). The document scanning unit irradiates an image-bearing surface of a document placed on a platen (not shown) manually or by an automatic document feeder (not shown) with light from the light source, and thereby obtains reflection light. The reflection mirror and the optical lens form an image of the obtained reflection light on the CCD line sensor. The CCD line sensor executes photo-electric conversion of the formed reflection light image successively, and outputs the result as image data to image processing unit 35.

Printer unit 34 includes an image memory 48 and a printing unit 50. Image memory 48 includes an RAM, and temporarily stores print data page by page. Image memory 48 temporarily stores, page by page, print data input from image processing unit 35 or print data transmitted from communication terminal 12, to be transmitted to printing unit 50, in accordance with an instruction, for example, from main controller 24. Image memory 48 outputs the stored print data to printing unit 50, in synchronization with image formation by printing unit 50. Printing unit 50 includes a photoreceptor drum, a charger, an LSU (Laser Scanning Unit), a developer, a transfer device, a cleaning device and a fixing device (all not shown), as well as a toner cartridge detachably attached to printing device 10. Printing unit 50 further includes a manual feed tray and first and second paper feed trays (all not shown) detachably attached to printing device 10. These paper feed trays are arranged from top to bottom in this order. These paper feed trays hold sheets of recording paper, and feed sheets of recording paper to a paper feeding unit (not shown). The manual feed tray is for allowing the user to manually set a desired sheet of recording paper. The first and second paper feed trays are to hold sheets of recording paper of different sizes. In response to an instruction from main controller 24 or the like, printing unit 50 forms an image based on the print data transmitted from image memory 48, on the sheet of recording paper fed from any of the paper feed trays through the paper feeding unit.

Image processing unit 35 includes an MPU (Micro Processing Unit; not shown). Image processing unit 35 performs various processes including a prescribe image processing such as rasterization, and thereby creates print data of a prescribed tone, which is output to printer unit 34.

Operation panel 36 includes a touch-panel and a liquid crystal display (both not shown). The touch-panel and the liquid crystal display are formed in a superposed manner, and provide an interactive operation interface to the user. Specifically, operation panel 36 receives an instruction given as an input operation by the user on the touch-panel, and outputs a control signal in accordance with the instruction to main controller 24. In accordance with the input instruction, main controller 24 displays the state of printing device 10 and information related to the contents of instruction, on the liquid crystal display. Operation panel 36 further includes a power button for inputting instructions to turn on and off the power, as well as various hardware keys including a print start key for starting a print job.

LAN I/F 38 provides an interface to network 20. Printing device 10 can perform data communication in accordance with a prescribed communication protocol with communication terminal 12 on network 20, through LAN I/F 38.

Power control unit 39 is electrically connected to an external power supply 52. Power control unit 39 obtains electric power necessary for operations of various units in printing device 10, and supplies the obtained electric power to various units in printing device 10.

In the present embodiment, printing device 10 has a power saving mode function for reducing power consumption of the body of printing device 10. Specifically, power control unit 39 controls ON/OFF of power supply to main controller 24, sub-controller 25, LAN I/F 38 and printer unit 34. Thus, power control unit 39 sets the state of printing device 10 to any of normal mode and first and second power saving modes. In the following, the first and second energy saving modes may be generally referred to as “energy saving mode.”

In the normal mode, power control unit 39 supplies power to all of the various units and components in printing device 10. In the normal mode, it is possible to perform various operations in the copy mode, print mode and scanner mode, and to execute the process for transmitting the image correction data.

In the first energy saving mode, power control unit 39 turns off the power supply to units and components (for example, printer unit 34, the liquid crystal display of operation panel 36 and various motors (not shown)) not related to communication in accordance with a protocol represented by names such as SNMP (Simple Network Management Protocol), SOAP (Simple Object Access Protocol) and TCP/IP (Transmission Control Protocol/Internet Protocol). Specifically, in the first energy saving mode, power is supplied to main controller 24, sub-controller 25 and LAN I/F 38 for executing the SOAP communication process or the like. In the first energy saving mode, response to MIB (Management Information Base) not involving the printing process is made, and the process for transmitting the image correction data can be executed.

In the second energy saving mode, power control unit 39 supplies electric power only to sub-controller 25 and LAN I/F 38. In the second energy saving mode, power supply to main controller 24, of which power consumption is relatively large, is turned off. Therefore, power consumption can further be reduced than in the first energy saving mode. In the second energy saving mode, only the response to a specific MIB is made, and the process for transmitting the image correction data cannot be executed.

By the operations of various units and components mentioned above, printing device 10 executes any of the copy mode, print mode, scanner mode and the like, in accordance with an instruction by a user input operation through operation panel 36 or an instruction from communication terminal 12 or the like. In the copy mode, printing device 10 reads a document image and prints the image on a sheet of recording paper. In the print mode, printing device 10 receives print data transmitted from communication terminal 12 or the like, and prints the data on a sheet of recording paper. In the scanner mode, printing device 10 reads a document, image and transmits the image data to communication terminal 12 or the like.

### Communication Terminal 12

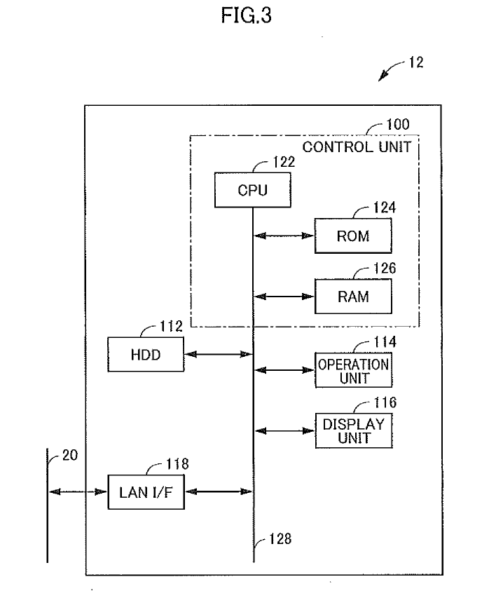

Referring to FIG. 3, communication terminal 12 includes a control unit 100, an HDD 112, an operation unit 114, a display unit 116 and an LAN I/F 118.

Control unit 100 is substantially a computer, and it includes a CPU 122, an ROM 124 and an RAM 126. To CPU 122, a BUS line 128 is connected. To BUS line 128, ROM 124 and RAM 126 are electrically connected. CPU 122 executes various computer programs in accordance with an instruction from an external device including printing device 10 or from operation unit 114 or the like, and thereby executes operations of various units and components of communication terminal 12 and executes a desired process such as communication with an external device. The various computer programs mentioned above are stored in advance in ROM 124 or HDD 112, and at the time of execution of a desired process, read from ROM 124 or HDD 112 and transferred to RAM 126. CPU 122 reads and interprets a program instruction from an address in RAM 126 designated by a value stored in a register (not shown) referred to as a program counter, in CPU 122. CPU 122 reads data necessary for an operation from an address designated by the read instruction, and executes the operation corresponding to the instruction on the data. The result of execution is also stored at the address designated by the instruction, in the register in CPU 122, HDD 112, RAM 126 and the like.

To BUS line 128, HDD 112, operation unit 114, display unit 116 and LAN I/F 118 are further electrically connected.

HDD 112 includes a magnetic recording medium and stores various data including image data. HDD 112 stores a printer driver program (hereinafter simply referred to as a “printer driver”) (for example, GDI (Graphic Device Interface) driver) for causing printing device 10 to execute a print job. By executing the printer driver, communication terminal 12 can realize the operation of causing printing device 10 to print an image based on image data designated by the user, an image correction data acquisition process as will be described later, and the print data creation process.

HDD 112 further stores various pieces of application software. By executing the application software, communication terminal 12 can realize operations such as creation of desired image data. Examples of application software include spread sheet software “Microsoft Excel” (registered trademark) and word processor software “Microsoft Word” (registered trademark) included in “Microsoft Office” (registered trademark).

Operation unit 114 represents an input device including a keyboard, enabling various inputs and character inputs in accordance with a user instruction, and a pointing device such as a mouse. Operation unit 114 is connected to BUS line 128 through an interface (not shown).

Display unit 116 is a display device implemented, for example, by a liquid crystal display, for displaying results of processing and the like of communication terminal 12. Display unit 116 is connected to BUS line 128 through a video circuit (not shown) driving display unit 116.

Communication terminal 12 is connected to network 20 through LAN I/F 118, and it is capable of data communication with external devices including printing device 10, connected to network 20.

To various units and components of communication terminal 12, a power source (not shown) is connected, and electric power is supplied from the power source, enabling operations of various units and components of communication terminal 12.

### Functional Block Configuration

### Printing Device 10

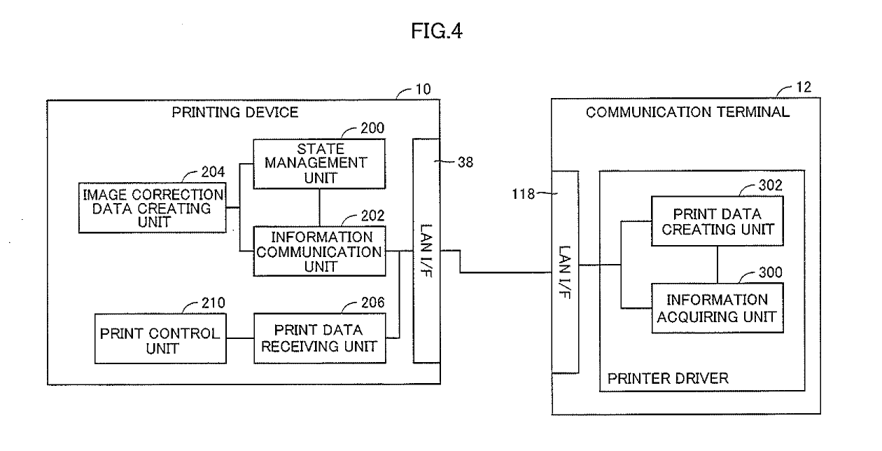

Referring to FIG. 4, printing device 10 includes a state management unit 200, an information communication unit 202, an image correction data creating unit 204, a print data receiving unit 206, and a print control unit 210. State management unit 200 and information communication unit 202 are actually realized by computer programs executed by a sub-CPU (not shown) in sub-controller 25. State management unit 200 and information communication unit 202 operate regardless of whether printing device 10 is in the normal mode or in the energy saving mode. Image correction data creating unit 204, print data receiving unit 206 and print control unit 210 are actually realized by computer programs executed by CPU 40 of main controller 24.

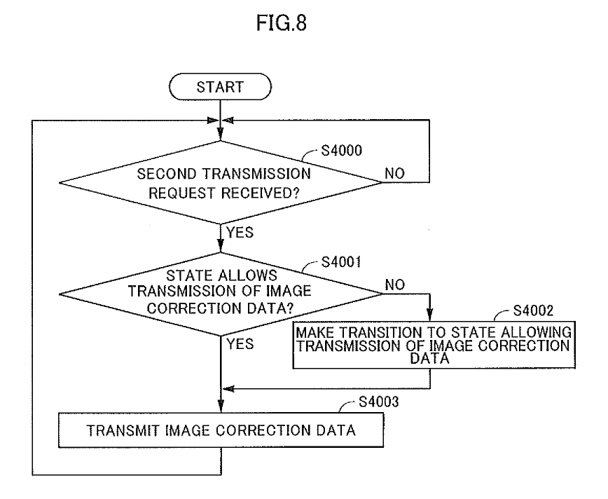

State management unit 200 manages the state of printing device 10. State management unit 200 controls operations of power control unit 39 to set the state of printing device 10 to the energy saving mode or to the normal mode. By way of example, when a predetermined prescribed time period passes without any operation of printing device 10, state management unit 200 causes a state transition of printing device 10 to the operational mode of smaller power consumption (for example, from the normal mode to the first energy saving mode, or from the first energy saving mode to the second energy saving mode). State management unit 200 causes a state transition of printing device 10 from the second energy saving mode to the normal mode or to the first energy saving mode by executing a process (S4002 of FIG. 8) in the image correction data transmission process, which will be described later.

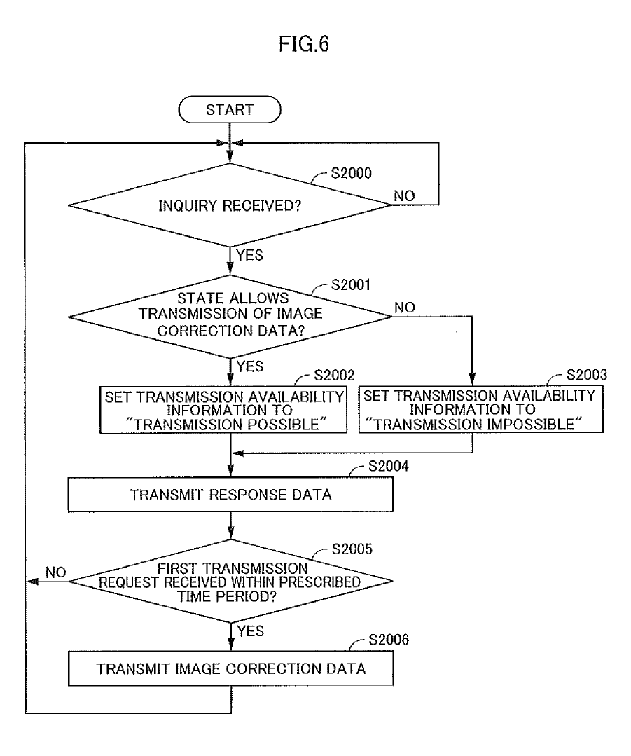

Information communication unit 202 executes the process of S2000 to S2006 (see FIG. 6) of the process for transmitting transmission availability information as will be described later, and the process of S4000, S4001 and S4003 (see FIG. 8) of the image correction data transmission process as will be described later,

Image correction data creating unit 204 periodically creates image correction data corresponding to the current state of printing device 10. The image correction data is data for adjusting image density, and includes table data for converting pixels to dither pattern, and gamma correction values. The image correction data is created by periodically executing the calibration process described below. In the calibration process, image correction data creating unit 204 forms, at a prescribed timing not related to image formation, a plurality of test images (toner patches) having different densities on an image carrier such as the photoreceptor drum, an intermediate transfer body or a transfer body, and the densities of test images (amount of adhering toner) are measured by a density sensor (optical sensor). Based on the results of measurement by the density sensor, image correction data creating unit 204 sets parameter or parameters having influence on the image density, and thereby creates the image correction data. By way of example, if it is indicated by the results of measurement by the density sensor that the image density is low, image correction data creating unit 204 sets values of the dither pattern table data such that filled area of the created dither pattern increases.

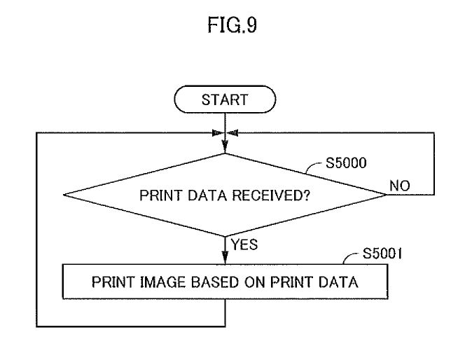

Print data receiving unit 206 receives the print data transmitted from communication terminal 12 through LAN I/F 38 (see, for example, S5000 (FIG. 9) of the print process as will be described later).

Print control unit 210 causes printer unit 34 to execute the print process based on the received print data, so that an image based on the print data is formed on a recording medium (for example, S5001 of the printing process (see FIG. 9)).

### Communication Terminal 12

Referring to FIG. 4, communication terminal 12 includes an information acquiring unit 300 and a print data creating unit 302. These units are actually realized by the printer driver executed by CPU 122 of control unit 100.

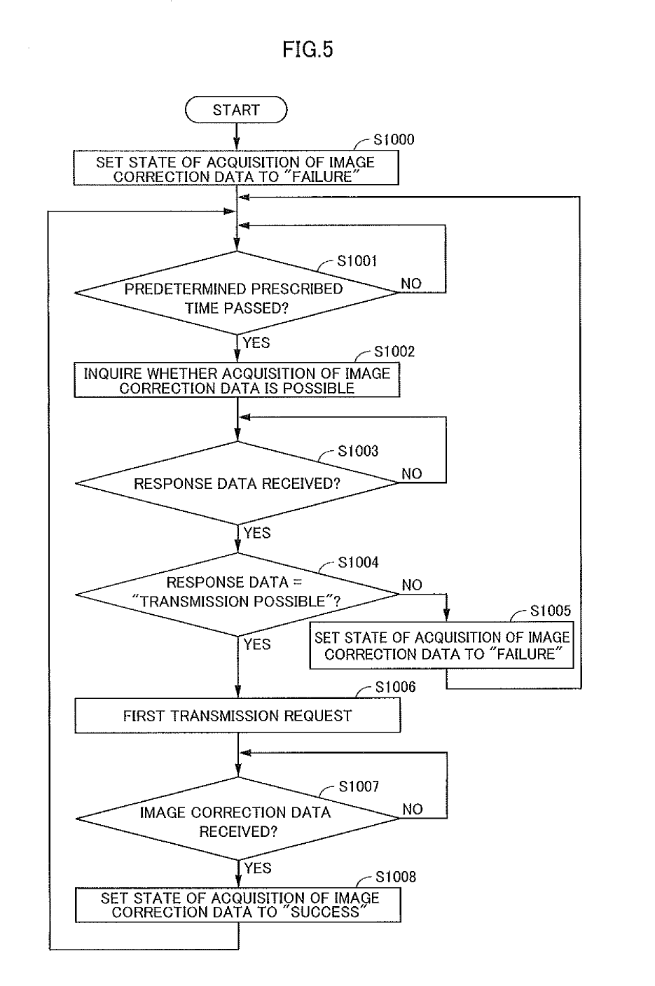

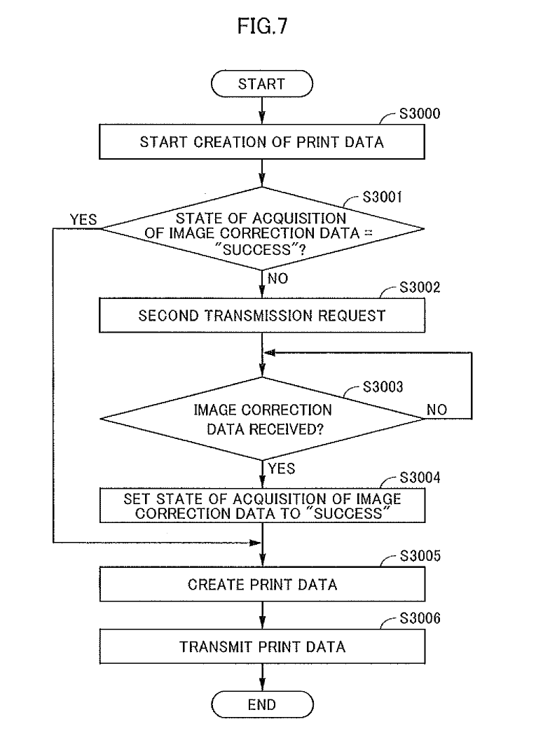

Information acquiring unit 300 executes S1000 to S1008 (see FIG. 5) of an image correction data acquiring process as will be described later, and S3001 to S3004 (see FIG. 7) of a print data creating process as will be described later.

Print data creating unit 302 executes S3000, S3005 and S3006 (see FIG. 7) of the print data creating process as will be described later.

### Software Configuration

(Image Correction Data Acquiring Process)

The program for realizing the image correction data acquiring process is activated when the power of communication terminal 12 is turned on, and it ends when the power is turned off.

Referring to FIG. 5, the program includes the following steps (hereinafter simply denoted by “S”) 1000 to 1002. At S1000, information acquiring unit 300 sets state information (hereinafter simply referred to as “state”) of acquisition of the image correction data to “failure.” Information acquiring unit 300 waits until a predetermined prescribed time passes, by repeating step S1001. If it is determined at S1001 that the predetermined prescribed time has passed (YES), S1002 is executed. At S1002, information acquiring unit 300 inquires of printing device 10 whether acquisition of the image correction data is possible.

The program further includes S1003 and S1004. Information acquiring unit 300 waits until a response data transmitted from printing device 10 is received, by repeating S1003. If it is determined at S1003 that the response data is received (YES), S1004 is executed. At S1004, information acquiring unit 300 determines whether or not the information given by the response data represents “transmission possible.”

The program further includes S1005. If the determination at S1004 is not “transmission possible” (NO), S1005 is executed. Specifically, this step is executed if the information given by the response data represents “transmission impossible.” At S1005, information acquiring unit 300 sets the state of acquisition of the image correction data to “failure.” After the process of S1005, the control returns to S1001.

The program further includes S1006 and S1007. If the determination at S1004 is “transmission possible” (YES), S1006 is executed. At S1006, information acquiring unit 3000 requests printing device 10 to transmit the image correction data (in the following, this request may be denoted as “first transmission request”). Information acquiring unit 300 waits until the image correction data transmitted from printing device 10 is received, by repeating S1007.

The program further includes S1008. If it is determined at S1007 that the image correction data is received (YES), S1008 is executed. At S1008, information acquiring unit 300 sets the state of acquisition of the image correction data to “success.” After the process of S1008, the control returns to S1001.

(Process for Transmitting Transmission Availability Information)

The program for realizing the process for transmitting the transmission availability information is activated when the power of printing device 10 is turned on, and it ends when the power is turned off.

Referring to FIG. 6, the program includes S2000 and S2001. Information communication unit 202 waits until the inquiry as to whether acquisition of the image correction data is possible, which is transmitted from communication terminal 12, is received, by repeating S2000. If it is determined at S2000 that the inquiry is received (YES), S2001 is executed. At S2001, information communication unit 202 determines whether or not the state of printing device 10 allows transmission of the image correction data to communication terminal 12.

The program further includes S2002 and S2003. If it is determined at S2001 that transmission of the image correction data is possible (YES), S2002 is executed. At S2002, information communication unit 202 sets a piece of information representing whether or not the state of printing device 10 allows transmission of the image correction data (hereinafter referred to as the “transmission availability information”) to “transmission possible.” If it is determined at S2001 that the state does not allow transmission of the image correction data (NO), S2003 is executed. At S2003, information communication unit 202 sets the transmission availability information to “transmission impossible.” In the present embodiment, the state that allows transmission of the image correction data represents the normal mode and the first energy saving mode, and the state not allowing transmission of the image correction data represents the second energy saving mode.

The program further includes S2004 to S2006. At S2004, information communication unit 202 transmits the transmission availability information set at S2002 or S2003 as the response data, to communication terminal 12. At S2005, information communication unit 202 determines whether or not the first transmission request transmitted from communication terminal 12 has been received within a predetermined prescribed time period. If it is determined at S2005 that the first transmission request has been received within the predetermined prescribed time period (YES), S2006 is executed. At S2006, information communication unit 202 transmits a request command requesting transmission of the image correction data to main controller 24. In response, main controller 24 executes the process for transmitting the image correction data to communication terminal 12 through LAN I/F 38. After the process of S2006, or if it is determined at S2005 that the first transmission request has not been received within the predetermined prescribed time period (NO), the control returns to S2000.

(Print Data Creating Process)

The program for realizing the print data creating process is activated when an instruction requesting creation of print data is issued from application software such as “Microsoft Word” (registered trademark).

Referring to FIG. 7, the program includes S3000 and S3001. At S3000, information acquiring unit 300 starts creation of print data. At S3001, information acquiring unit 300 determines whether or not the state of acquisition of image correction data at the time of starting creation of print data is “success.”

The program further includes S3002 and S3003. If it is determined at S3001 that the state of acquisition of the image correction data is not “success” (NO), that is, if it is “failure,” S3002 is executed. At S3002, information acquiring unit 300 requests printing device 10 to transmit the image correction data (hereinafter this may be referred to as the “second transmission request”). Information acquiring unit 300 waits until the image correction data transmitted from printing device 10 is received, by repeating S3003.

The program further includes S3004 to S3006. If it is determined at S3003 that the image correction data is received (YES), S3004 is executed. At S3004, information acquiring unit 300 sets the state of acquisition of the image correction data to “success.” If it is determined at S3001 that the state of acquisition of the image correction data is “success” (YES) or after the process of S3004, S3005 is executed. At S3005, information acquiring unit 300 creates print data by performing the image correction process based on the received image correction data. At S3006, information acquiring unit 300 transmits the created print data to printing device 10.

(Image Correction Data Transmission Process)

The program for realizing the image correction data transmission process is activated when the power of printing device 10 is turned on, and it ends when the power is turned off.

Referring to FIG. 8, the program includes S4000 and S4001. Information communication unit 202 waits until the second transmission request transmitted from communication terminal 12 is received, by repeating S4000. If it is determined at S4000 that the second transmission request is received (YES), S4001 is executed. At S4001, information communication unit 202 determines whether or not the state of printing device 10 allows transmission of the image correction data to communication terminal 12.

The program further includes S4002 and S4003. If it is determined at S4001 that the state does not allow transmission of the image correction data (NO), S4002 is executed. At S4002, state management unit 200 makes a state transition of printing device 10 to a state that allows transmission of the image correction data. If it is determined at S4001 that the state allows transmission of the image correction data (YES), or after the process of S4002, S4003 is executed. At S4003, information communication unit 202 transmits a request command requesting transmission of the image correction data, to main controller 24. Thus, information communication unit 202 causes main controller 24 to execute the process for transmitting the image correction data to communication terminal 12 through LAN I/F 38. After the process of S4003, the control returns to S4000.

(Printing Process)

The program for realizing the printing process is activated when the power of printing device 10 is turned on, and it ends when the power is turned off.

Referring to FIG. 9, the program includes S5000 and S5001. Print data receiving unit 206 waits until the print data is received, by repeating S5000. If it is determined at S5000 that the print data is received (YES), S5001 is executed. At S5001, print control unit 210 causes printer unit 34 to execute printing of an image based on the received print data. After the process of S5001, the control returns to S5000.

### Operation

Referring to FIGS. 1 to 9, printing device 10 and communication terminal 12 in accordance with the present embodiment operate in the following manner. The operations for realizing general functions of printing device 10 and communication terminal 12 except for the operations described below are the same as those of the conventional printing device and communication terminal. In the operations described below, it is assumed that the power of printing device 10 is on.

The user turns on the power of communication terminal 12. When the power is turned on, in communication terminal 12, information acquiring unit 300 sets the state of acquisition of the image correction data to “failure” (S1000), and waits until a predetermined prescribed time period passes (S1001). When the predetermined prescribed time period passes (YES at S1001), information acquiring unit 300 inquires of printing device 10 whether or not acquisition of the image correction data is possible through LAN I/F 118 (S1002). This inquiry is made, for example, by obtaining MIB by SNMP. After the inquiry, information acquiring unit 300 waits until the response data transmitted from printing device 10 is received (S1003).

In printing device 10, when the inquiry sent from communication terminal 12 is received through LAN I/F 38 (YES at S2000), information communication unit 202 determines whether or not the state of printing device 10 allows transmission of the image correction data to communication terminal 12 (S2001). The determination is made based on the result of response to the inquiry, obtained by the inquiry from information communication unit 202 to state management unit 208 about the state of printing device 10.

If it is determined that the state of printing device 10 allows transmission of the image correction data, that is, it is in the normal mode or in the first energy saving mode (YES at S2001), information communication unit 202 sets the transmission availability information to “transmission possible” (S2002). After setting “transmission possible,” information communication unit 202 transmits the set transmission availability information as the response data to communication terminal 12 through LAN I/F 38 (S2004).

On the other hand, if it is determined that the state of printing device 10 does not allow transmission of the image correction data, that is, it is in the second energy saving mode (NO at S2001), information communication unit 202 sets the transmission availability information to “transmission impossible” (S2003). After setting “transmission impossible,” information communication unit 202 transmits the set transmission availability information as the response data to communication terminal 12 through LAN I/F 38 (S2004).

In communication terminal 12, if the response data transmitted from printing device 10 is received (YES at S1003), information acquiring unit 300 determines whether or not the information represented by the response data is “transmission possible” (S1004).

If it is determined that the information represented by the response data is “transmission possible” (YES at S1004), information acquiring unit 300 transmits the first transmission request to printing device 10 through LAN I/F 118 (S1006). This request is made using, for example a protocol such as SOAP or TCP/IP. After the first transmission request, information acquiring unit 300 waits until the image correction data transmitted from printing device 10 is received (S1007).

In printing device 10, when the first transmission request is received within a predetermined prescribed time period through LAN I/F 38 (YES at S2005), information communication unit 202 transmits the request command requesting transmission of the image correction data to main controller 24. Thus, information communication unit 202 causes main controller 24 to execute the process for transmitting the image correction data to communication terminal 12 through LAN I/F 38 (S2006). It is assumed that information communication unit 202 acquires the image correction data to be transmitted, from image correction data creating unit 204.

In communication terminal 12, when the image correction data is received through LAN I/F 118 (YES at S1007), information acquiring unit 300 sets the state of acquisition of the image correction data to “success” (S1008). On the other hand, if it is determined that the information represented by the response data is “transmission impossible” (NO at S1004), information acquiring unit 300 sets the state of acquisition of the image correction data to “failure” (S1005).

As described above, communication terminal 12 periodically makes a request for acquiring the image correction data, and if the state of printing device 10 is in the normal mode or in the first energy saving mode, printing device 10 transmits the image correction data to communication terminal 12.

The user makes an instruction requesting creation of print data using application software such as “Microsoft Office Word” (registered trademark) by an input operation on operation unit 114 of communication terminal 12. When this instruction is made, in communication terminal 12, print data creating unit 302 starts creation of the print data (S3000). When creation of the print data starts, information acquiring unit 300 determines whether or not the state of acquisition of the image correction data, at the time when creation of the print data is started in accordance with the instruction of print data creating unit 302, is “success”(S3001).

(If the state of acquisition of image correction data is “failure”)

If it is determined that the state of acquisition of the image correction data is not “success” (NO at S3001), that is, if it is “failure,” information acquiring unit 300 transmits the second transmission request to printing device 10 through LAN I/F 118 (S3002), and waits until the image correction data transmitted from printing device 10 is received (S3003).

In printing device 10, information communication unit 202 receives the second transmission request transmitted from communication terminal 12 through LAN I/F 38 (YES at S4000), and determines whether or not the state allows transmission of the image correction data to communication terminal 12 (S4001).

If it is determined by information communication unit 202 that the state of printing device 10 does not allow transmission of the image correction data, that is, it is in the second energy saving mode (NO at S4001), state management unit 208 makes a state transition of printing device 10 to the state allowing transmission of the image correction data, that is, to the normal mode or to the first energy saving mode (S4002). After the transition, information communication unit 202 transmits a request command requesting transmission of the image correction data to main controller 24. Thus, information communication unit 202 causes main controller 24 to execute the process for transmitting the image correction data to communication terminal 12 through LAN I/F 38 (S4003).

On the other hand, if it is determined by information communication unit 202 that the state of printing device 10 allows transmission of the image correction data, that is, it is in the normal mode or in the first energy saving mode (YES at S4001), a state transition of printing device 10 by state management unit 208 does not take place, and information communication unit 202 transmits the request command requesting transmission of the image correction data to main controller 24. Thus, information communication unit 202 causes main controller 24 to execute the process for transmitting the image correction data to communication terminal 12 through LAN I/F 38 (S4003). It is assumed that information communication unit 202 acquires the image correction data to be transmitted, from image correction data creating unit 204.

In communication terminal 12, information acquiring unit 300 receives the image correction data through LAN I/F 118 (YES at S3003), and sets the state of acquisition of the image correction data to “success” (S3004).

In response to setting of “success” by information acquiring unit 300, print data creating unit 302 performs the process of image correction based on the received image correction data to create print data (S3005), and transmits the created print data to printing device 10 through LAN I/F 118 (S3006).

In printing device 10, print data receiving unit 206 receives the print data transmitted from communication terminal 12 through LAN I/F 38 (YES at S5000). After receiving the print data, print control unit 210 causes printer unit 34 to execute the printing process based on the received print data (S5001).

(If the state of acquisition of print correction data is “success”)

If it is determined that the state of acquisition of the image correction data is “success” (YES at S3001), information acquiring unit 300 creates print data by performing the image correction process based on the last-received image correction data (S3005), and transmits the created print data to printing device 10 through LAN I/F 118 (S3006).

In printing device 10, print data receiving unit 206 receives the print data transmitted from communication terminal 12 through LAN I/F 38 (YES at S5000). After receiving the print data, print control unit 210 causes printer unit 34 to execute the printing process based on the received print data (S5001).

As described above, if the acquisition of image correction data as is periodically done by the communication terminal 12 is in the failed state, printing device 10 transmits the image correction data to communication terminal 12 when communication terminal 12 creates the print data. At this time, if the state of printing device 10 is in the second energy saving mode, printing device 10 makes a state transition to the normal mode or to the first energy saving mode and, thereafter, transmits the image correction data.

### Second Embodiment

Print system 1 in accordance with a second embodiment of the present invention has the same configuration as print system 1 in accordance with the first embodiment described above, except that the programs for realizing the print data process and the image correction data transmission process are different. In the following, only the different configurations will be described.

### Functional Block Configuration

### Printing Device 10

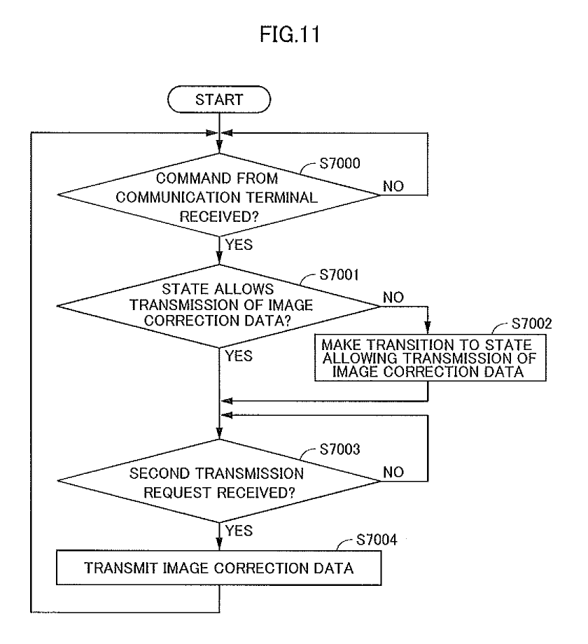

State management unit 200 executes S7002 (see FIG. 11) of the image correction data transmission process, as will be described later. Information communication unit 202 executes S7000, S7001, S7003 and S7004 (see FIG. 11) of the image correction data transmission process, as will be described later,

### Communication Terminal 12

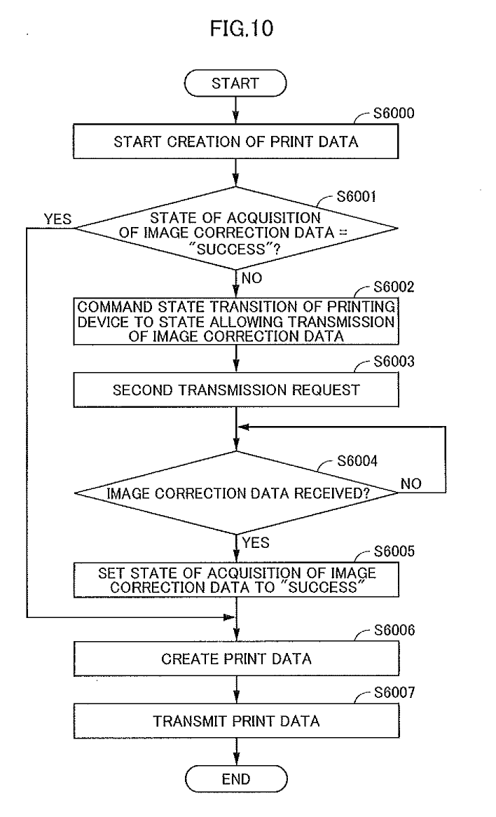

Information acquiring unit 300 executes S6001 to S6005 (see FIG. 10) of the print data creating process, as will be described later. Print data creating unit 302 executes S6000, S6006 and S6007 (see FIG. 10) of the print data creating process, as will be described later.

### Software Configuration

(Print Data Creating Process)

Referring to FIG. 10, in the program for realizing the print data creating process, the processes of S6000, S6001 and S6003 to S6007 are the same as those of S3000 to S3006 shown in FIG. 7. In the following, the process of S6002 will be described.

The program additionally includes S6002. If it is determined at S6001 that the state of acquisition of the image correction data is not “success” (NO), that is, if the stat is “failure,” S6002 is executed. At S6002, information acquiring unit 300 transmits a command requesting a state transition of printing device 10 to a state allowing transmission of the image correction data, to printing device 10.

(Image Correction Data Transmission Process)

The program for realizing the image correction data transmission process is activated when the power of printing device 10 is turned on, and it ends when the power is turned off.

Referring to FIG. 11, the program includes S7000 and S7001. Information communication unit 202 waits until the command requesting a state transition of printing device 10 to the state allowing transmission of the image correction data, transmitted from communication terminal 12, is received, by repeating S7000. If it is determined at S7000 that the command mentioned above is received (YES), S7001 is executed. At S7001, Information communication unit 202 determines whether or not the state of printing device 10 allows transmission of the image correction data to communication terminal 12.

The program further includes S7002 to S7004. If it is determined at S7001 that the state does not allow transmission of the image correction data (NO), S7002 is executed. At S7002, state management unit 200 makes a state transition of printing device 10 to the state allowing transmission of the image correction data. If it is determined at S7001 that the state allows transmission of the image correction data (YES) or after the process of S7002, S7003 is executed. Information communication unit 202 waits until the second transmission request transmitted from communication terminal 12 is received, by repeating S7003. If it is determined at S7003 that the second transmission request is received (YES), S7004 is executed. At S7004, information communication unit 202 transmits a request command requesting transmission of the image correction data, to main controller 24. Thus, information communication unit 202 causes main controller 24 to execute the process for transmitting the image correction data to communication terminal 12 through LAN I/F 38. After the process of S7004, the control returns to S7000.

### Operation

Referring to FIGS. 10 and 11, printing device 10 and communication terminal 12 in accordance with the present embodiment operate in the following manner. Except for the operations described in the following, the operations of printing device 10 and communication terminal 12 are the same as those of printing device 10 and communication terminal 12 of the first embodiment described above.

The user makes an instruction requesting creation of print data using application software such as “Microsoft Office Word” (registered trademark) by an input operation on operation unit 114 of communication terminal 12. When this instruction is made, in communication terminal 12, print data creating unit 302 starts creation of the print data (S6000). When creation of the print data starts, information acquiring unit 300 determines whether or not the state of acquisition of the image correction data, at the time when creation of the print data is started in accordance with the instruction of print data creating unit 302, is “success”(S6001).

(If the state of acquisition of image correction data is “failure”)

If it is determined that the state of acquisition of the image correction data is not “success” (NO at S6001), that is, if it is “failure,” information acquiring unit 300 transmits the command requesting a state transition of printing device 10 to the state allowing transmission of the image correction data, to printing device 10 through LAN I/F 118 (S6002). Thereafter, information acquisition unit 300 transmits the second transmission request (S6003), and waits until the image correction data transmitted from printing device 10 is received (S6004).

In printing device 10, if the above-described command transmitted from communication terminal 12 through LAN I/F 38 is received (YES at S7000), information communication unit 202 determines whether or not the state of printing device 10 allows transmission of the image correction data to communication terminal 12 (S7001). The determination is made based on the result of response to the inquiry, obtained by the inquiry from information communication unit 202 to state management unit 208 about the state of printing device 10.

If it is determined by information communication unit 202 that the state of printing device 10 does not allow transmission of the image correction data, that is, it is in the second energy saving mode (NO at S7001), state management unit 208 makes a state transition of printing device 10 to the state allowing transmission of the image correction data, that is, to the normal mode or to the first energy saving mode (S7002). After the state transition, information communication unit 202 determines that the second transmission request transmitted from communication terminal 12 is received through LAN I/F 38 (YES at S7003), and transmits the request command requesting transmission of the image correction data to main controller 24. Thus, information communication unit 202 causes main controller 24 to execute the process for transmitting the image correction data to communication terminal 12 through LAN I/F 38 (S7004).

On the other hand, if it is determined by information communication unit 202 that the state of printing device 10 allows transmission of the image correction data, that is, it is in the normal mode or in the first energy saving mode (YES at S7001), a state transition of printing device 10 by state management unit 208 does not take place. Information communication unit 202 determines that the second transmission request transmitted from communication terminal 12 is received through LAN I/F 38 (YES at S7003), and it transmits a request command requesting transmission of the image correction data to main controller 24. Thus, information communication unit 202 causes main controller 24 to execute the process for transmitting the image correction data to communication terminal 12 through LAN I/F 38 (S7004). It is assumed that information communication unit 202 acquires the image correction data to be transmitted, from image correction data creating unit 204.

In communication terminal 12, information acquiring unit 300 receives the image correction data through LAN I/F 118 (YES at S6004), and sets the state of acquisition of the image correction data to “success” (S6005).

In response to setting of “success” by information acquiring unit 300, print data creating unit 302 creates the print data based on the received image correction data (S6006), and transmits the created print data to printing device 10 through LAN I/F 118 (S6007).

In printing device 10, print data receiving unit 206 receives the print data transmitted from communication terminal 12 through LAN I/F 38 (YES at S5000). After receiving the print data, print control unit 210 causes printer unit 34 to execute the printing process based on the received print data (S5001).

(If the state of acquisition of print correction data is “success”)

If it is determined that the state of acquisition of the image correction data is “success” (YES at S6001), information acquiring unit 300 creates print data based on the last-received image correction data (S6006), and transmits the created print data to printing device 10 through LAN I/F 118 (S6007).

In printing device 10, print data receiving unit 206 receives the print data transmitted from communication terminal 12 through LAN I/F 38 (YES at S5000). After receiving the print data, print control unit 210 causes printer unit 34 to execute the printing process based on the received print data (S5001).

As described above, if the acquisition of image correction data as is periodically done by the communication terminal 12 is in the failed state, printing device 10 transmits the image correction data to communication terminal 12 when communication terminal 12 creates the print data. At this time, if the state of printing device 10 is in the second energy saving mode, printing device 10 makes a state transition to the normal mode or to the first energy saving mode, before transmitting the image correction data. Therefore, it becomes possible for printing device 10 to quickly transmit the image correction data in response to the second transmission request. Further, during S6002 to S6003, it is possible for printing device 10 to execute other processes. Therefore, user convenience can be improved.

### Third Embodiment

Print system 1 in accordance with the third embodiment of the present invention has the same configuration as print system 1 in accordance with the second embodiment, except that the program for realizing the image correction data acquiring process is different and that in place of the process for transmitting transmission availability information, a process for transmitting invalid image correction data as will be described later is executed. In the following, only the different configurations will be described.

### Functional Block Configuration

### Printing Device 10

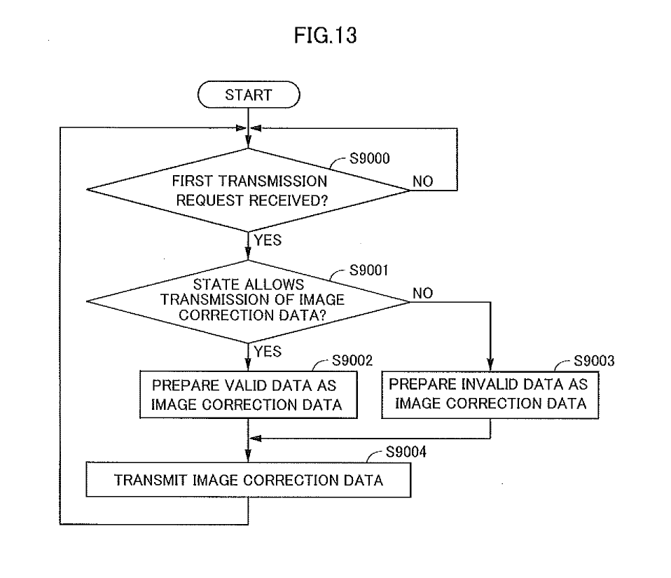

Information communication unit 202 executes process of S9000 to S9004 (see FIG. 13) of the process for transmitting invalid image correction data, as will be described later.

### Communication Terminal 12

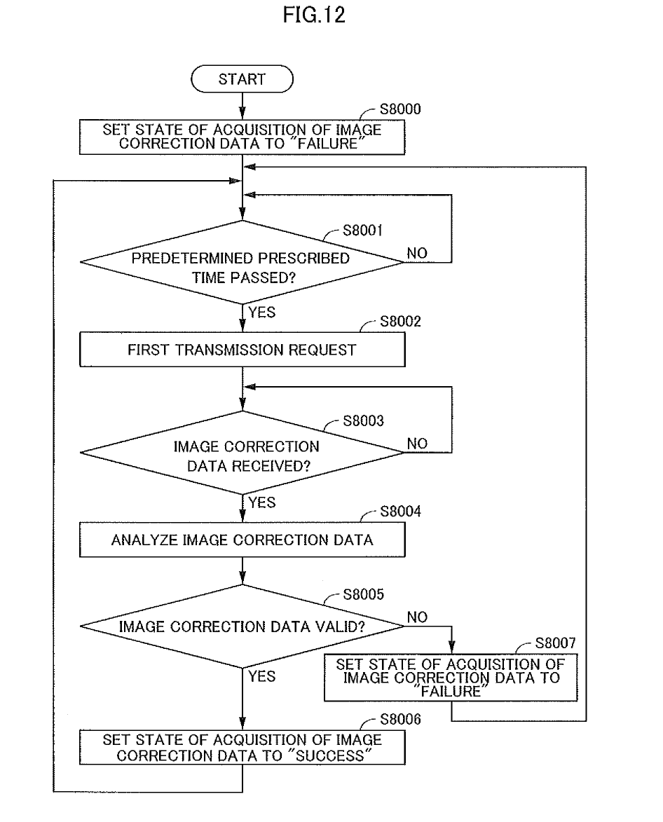

Information acquiring unit 300 executes S8000 to S8007 (see FIG. 12) of an image correction data acquiring process, as will be described later.

### Software Configuration

(Image Correction Data Acquiring Process)

The program for realizing the image correction data acquiring process is activated when the power of communication terminal 12 is turned on, and it ends when the power is turned off.

Referring to FIG. 12, the program includes S8000 to S8003. At S8000, information acquiring unit 300 sets the state of acquisition of the image correction data to “failure.” Information acquiring unit 300 waits until a predetermined prescribed time period passes, by repeating S8001. If it is determined at S8001 that the predetermined prescribed time period has passed (YES), S8002 is executed. At S8002, information acquiring unit 300 transmits the first transmission request to printing device 10. Information acquiring unit 300 waits until the image correction data transmitted from printing device 10 is received, by repeating S8003.

The program further includes S8004 and S8005. If it is determined at S8003 that the image correction data is received (YES), S8004 is executed. At S8004, information acquiring unit 300 analyzes the image correction data. At S8005, information acquiring unit 300 determines whether or not the image correction data is valid, based on the result of analysis.

The program further includes S8006 to S8008. If it is determined at S8005 that the image correction data is valid (YES), S8006 is executed. At S8006, information acquiring unit 300 sets the state of acquisition of the image correction data to “success.” If it is determined at S8005 that the image correction data is not valid (NO), that is, if it is determined to be invalid, S8007 is executed. At S8007, information acquiring unit 300 sets the state of acquisition of the image correction data to “failure.” After the process of S8006 and S8007, the control returns to S8001.

(Process for Transmitting Invalid Image Correction Data)

The program for realizing the process for transmitting invalid image correction data is activated when the power of printing device 10 is turned on, and it ends when the power is turned off.

Referring to FIG. 13, the program includes S9000 and S9001. Information communication unit 202 waits until the first transmission request transmitted from communication terminal 12 is received, by repeating S9000. If it is determined at S9000 that the first transmission request is received (YES), S9001 is executed. At S9001, information communication unit 202 determines whether or not the state of printing device 10 allows transmission of the image correction data to communication terminal 12.

The program further includes S9002 and S9003. If it is determined at S9001 that the state of printing device 10 allows transmission of the image correction data (YES), S9002 is executed. At S9002, information communication unit 202 prepares valid data as the image correction data. If it is determined at S9001 that the state does not allow transmission of the image correction data (NO), S9003 is executed. At S9003, information communication unit 202 prepares invalid data as the image correction data.

The program further includes S9004. After the process of S9002 or after the process of S9003, S9004 is executed. At S9004, information communication unit 202 transmits the image correction data to communication terminal 12. If the process of S9004 is executed after S9002, at S9004, information communication unit 202 transmits a request command requesting transmission of the image correction data to main controller 24. Thus, information communication unit 202 causes main controller 24 to execute the process for transmitting the image correction data to communication terminal 12 through LAN I/F 38. On the other hand, if the process of S9004 is executed after the process of S9003, at S9004, information communication unit 202 directly transmits the image correction data to communication terminal 12. After the process of S9004, the control returns to S9000.

In the present embodiment, the valid data mentioned above refers to the normal image correction data acquired from image correction data creating unit 204. The invalid data refers, for example, to image correction data having all values in the table data for conversion of pixels to dither pattern set to 0 and the gamma correction value set to 0.

### Operation

Referring to FIGS. 12 and 13, printing device 10 and communication terminal 12 in accordance with the present embodiment operate in the following manner. Except for the operations described in the following, the operations of printing device 10 and communication terminal 12 are the same as those of printing device 10 and communication terminal 12 in accordance with the second embodiment described above.

The user turns on the power of communication terminal 12. When the power is turned on, in communication terminal 12, information acquiring unit 300 sets the state of acquisition of the image correction data to “failure” (S8000), and waits until a predetermined prescribed time period passes (S8001). If the predetermined prescribed time period passes (YES at S8001), information acquiring unit 300 transmits the first transmission request to printing device 10 through LAN I/F 118 (S8002), and waits until the image correction data transmitted from printing device 10 is received (S8003).

In printing device 10, when the first transmission request is received through LAN I/F 38 (YES at S9000), information communication unit 202 determines whether or not the state of printing device 10 allows transmission of the image correction data to communication terminal 12 (S9001). The determination is made based on the result of response to the inquiry, obtained by the inquiry from information communication unit 202 to state management unit 208 about the state of printing device 10.

If it is determined that the state of printing device 10 allows transmission of the image correction data, that is, the state is in the normal mode or in the first energy saving mode (YES at S9001), information communication unit 202 prepares valid data as the image correction data (S9002). It is assumed that information communication unit 202 obtains the image correction data to be transmitted, from image correction data creating unit 204. After the valid data is prepared, information communication unit 202 transmits a request command requesting transmission of the image correction data to main controller 24. Thus, information communication unit 202 causes main controller 24 to execute the process for transmitting the image correction data to communication terminal 12 through LAN I/F 38 (S9004).

If it is determined that the state of printing device 10 does not allow transmission of the image correction data, that is, the state is in the second energy saving mode (NO at S9001), information communication unit 202 prepares invalid data as the image correction data (S9003). At this time, the image correction data to be transmitted is created by information communication unit 202, and not acquired from image correction data creating unit 204. After the invalid data is prepared, information communication unit 202 transmits the image correction data to communication terminal 12 through LAN I/F 38 (S9004).

In communication terminal 12, if the image correction data is received through LAN I/F 118 (YES at S8003), information acquiring unit 300 analyzes the image correction data (S8004), and based on the result of analysis, determines whether or not the image correction data is valid (S8005).

If it is determined that the image correction data is valid (YES at S8005), information acquiring unit 300 sets the state of acquisition of the image correction data to “success” (S8006). On the other hand, if it is determined that the image correction data is not valid (NO at S8005), that is, if the data is invalid, information acquiring unit 300 sets the state of acquisition of the image correction data to “failure” (S8007).

As described above, communication terminal 12 periodically requests acquisition of the image correction data, and if the state of printing device 10 is in the normal mode or in the first energy saving mode, printing device 10 transmits the valid image correction data to communication terminal 12. It is possible for information acquiring unit 300 to determine whether the state of printing device 10 allows transmission of the image correction data or not, by determining whether the image correction data is valid or not. As a result, the process (S2000 and S2003 (see FIG. 6)) of setting the transmission availability information to “transmission possible” or “transmission impossible” on the side of printing device 10 becomes unnecessary, and a command or the like for determining the state of printing device 10 becomes unnecessary. As a result, various processes necessary for confirming the state of printing device 10 can further be simplified.

### Functions/Effects

According to the first embodiment described above, print system 1 includes a communication terminal 12 performing the image correction process based on the image correction data to create print data, and printing device 10 performing the print process based on the print data. In communication terminal 12, information acquiring unit 300 inquires of printing device 10 whether acquisition of the image correction data is possible, at every predetermined prescribed time interval. If the result of determination to the inquiry indicates that the acquisition of image correction data is possible, information acquiring unit 300 receives the image correction data transmitted from printing device 10, and sets the state of acquisition of the image correcting data to a state representing a success. Further, in response to reception of an instruction requesting creation of the print data, information acquiring unit 300 determines whether or not the state of acquisition of the image correction data represents a success. If it is determined that the state of acquisition of the image correction data does not represent a success, information acquiring unit 300 transmits the second transmission request to printing device 10, and receives the image correction data transmitted from printing device 10 in response to the second transmission request. In printing device 10, in response to reception of the inquiry from communication terminal 12, information communication unit 202 determines whether the state of printing device 10 is in the normal mode or the first energy saving mode. If it is determined that the state is in the normal mode or the first energy saving mode, information communication unit 202 transmits the image correction data to communication terminal 12. Further, in response to reception of the second transmission request, information communication unit 202 determines whether the state of printing device 10 is in the normal mode or the first energy saving mode. If it is determined that the state of printing device 10 is in the second energy saving mode, state management unit 200 causes a state transition of printing device 10 to the normal mode or to the first energy saving mode. If the state of printing device 10 is determined to be the normal mode or the first energy saving mode, or if the state transition has been made, information communication unit 202 transmits the image correction data to communication terminal 12.

As described above, when a request for acquisition of the image correction data is issued, as is periodically done by the communication terminal 12 and the state of printing device 10 is in the normal mode or in the first energy saving mode, printing device 10 transmits the image correction data. Therefore, it becomes unnecessary to make a transition or cancellation of the state for transmitting the image correction data. As a result, as compared with the case in which the image correction data is transmitted in any state, power consumption can be reduced.

If the acquisition of image correction data as is periodically done by the communication terminal 12 is in the failed state, printing device 10 transmits the image correction data to communication terminal 12 when communication terminal 12 creates the print data. At this time, if the state of printing device 10 is in the second energy saving mode, printing device 10 makes a state transition to the normal mode or to the first energy saving mode and, thereafter, transmits the image correction data. As a result, it becomes possible for communication terminal 12 to create the print data based on the image correction data corresponding to the latest state of printing device 10.

According to the second embodiment, in communication terminal 12, information acquiring unit 300 inquires of printing device 10 whether or not acquisition of the image correction data is possible, at every predetermined prescribed time interval. If the result of determination to the inquiry indicates that acquisition of the image correction data is possible, information acquiring unit 300 receives the image correction data transmitted from printing device 10, and sets the state of acquisition of the image correction data to a state representing a success. Further, in response to reception of an instruction requesting creation of the print data, information acquiring unit 300 determines whether or not the state of acquisition of the image correction data represents a success. If it is determined that the state of acquisition of the image correction data does not represent a success, information acquiring unit 300 commands printing device 10 to make state transition to the normal mode or first energy saving mode. Thereafter, information acquiring unit 300 transmits the second transmission request, and receives the image correction data transmitted from printing device 10 in response to the second transmission request. In response to reception of the inquiry from communication terminal 12, information communication unit 202 determines whether the state of printing device 10 is in the normal mode or the first energy saving mode. If it is determined to be the normal mode or the first energy saving mode, information communication unit 202 transmits the image correction data to communication terminal 12. Further, receiving the command from communication terminal 12, information communication unit 202 determines whether the state of printing device 10 is in the normal mode or the first energy saving mode. If it is determined that the state of printing device 10 is the second energy saving mode, state management unit 200 causes a state transition of printing device 10 to the normal mode or to the first energy saving mode. Further, in response to reception of the second transmission request, information communication unit 202 transmits the image correction data to communication terminal 12.

As described above, when a request for acquisition of the image correction data is issued, as is periodically done by the communication terminal 12 and the state of printing device 10 is in the normal mode or in the first energy saving mode, printing device 10 transmits the image correction data. Therefore, it becomes unnecessary to make a transition or cancellation of the state for transmitting the image correction data. As a result, as compared with the case in which the image correction data is transmitted in any state, power consumption can be reduced.

If the acquisition of image correction data as is periodically done by the communication terminal 12 is in the failed state, printing device 10 transmits the image correction data to communication terminal 12 when communication terminal 12 creates the print data. At this time, if the state of printing device 10 is in the second energy saving mode, printing device 10 makes a state transition to the normal mode or to the first energy saving mode before transmitting the image correction data. As a result, it becomes always possible for communication terminal 12 to create the print data based on the image correction data corresponding to the latest state of printing device 10.

According to the first and second embodiments described above, in communication terminal 12, information acquiring unit 300 receives the result of determination to the inquiry, transmitted from printing device 10. If the received result of determination indicates that acquisition of the image correction data is possible, information acquiring unit 300 transmits the first transmission request to printing device 10. In printing device 10, if it is determined that the state of printing device 10 is in the normal mode or the first energy saving mode, information communication unit 202 transmits, as the result of determination to the inquiry, a piece of information indicating that acquisition of the image correction data is possible, to communication terminal, and in response to reception of the first transmission request, transmits the image correction data to communication terminal 12.

Accordingly, it becomes possible for communication terminal 12 to more reliably obtain the result of determination as to whether acquisition of the image correction data is possible, and hence, power consumption can more reliably be reduced.

Further, according to the first and second embodiments described above, in communication terminal 12, if the result of determination to the inquiry indicates that acquisition of the image correction data is impossible, information acquiring unit 300 sets the state of acquisition of the image correction data to a state representing a failure. In printing device 10, if it is determined that the state of printing device 10 is in the second energy saving mode, information communication unit 202 transmits, as the result of determination to the inquiry, a piece of information indicating that acquisition of the image correction data is impossible, to communication terminal 12.

Accordingly, it becomes possible to more accurately determine whether or not the state of acquisition of the image correction data represents a success. Therefore, communication terminal 12 can more reliably acquire the image correction data corresponding to the latest state of printing device 10.

According to the third embodiment, in communication terminal 12, information acquiring unit 300 transmits the first transmission request to printing device 10 at every predetermined prescribed time interval, receives the image correction data transmitted from printing device 10 in response to the first transmission request, analyzes the received image correction data, and determines, based on the result of analysis, whether or not the image correction data is valid. If it is determined that the image correction data is valid, information acquiring unit 300 sets the state of acquisition of the image correction data to a state representing a success. Further, in response to reception of an instruction requesting creation of print data, information acquiring unit 300 determines whether or not the state of acquisition of the image correction data represents a success, and if it is determined not to represent a success, commands printing device 10 to make a state transition to the normal mode or to the first energy saving mode. Thereafter, information acquiring unit 300 transmits the second transmission request, and receives the image correction data transmitted from printing device 10 in response to the second transmission request. In printing device 10, in response to reception of the first transmission request, information communication unit 202 determines whether or not the state of printing device 10 is the normal mode or the first energy saving mode. If the state of printing device 10 is determined to be the normal mode or the first energy saving mode, information communication unit 202 transmits valid image correction data to communication terminal 12. Further, in response to reception of the command from communication terminal 12, information communication unit 202 determines whether or not the state of printing device 10 is the normal mode or the first energy saving mode. If it is determined that the state of printing device 10 is the second energy saving mode, state management unit 200 causes a state transition of printing device 10 to the normal mode or the first energy saving mode. Further, in response to reception of the second transmission request, information communication unit 202 transmits the image correction data to communication terminal 12.

As described above, when a request for acquisition of the image correction data is issued, as is periodically done by the communication terminal 12, and the state of printing device 10 is in the normal mode or in the first energy saving mode, printing device 10 transmits valid image correction data. Therefore, it becomes unnecessary to make a transition or cancellation of the state for transmitting the image correction data. As a result, as compared with the case in which the image correction data is transmitted in any state, power consumption can be reduced.

If the acquisition of image correction data as is periodically done by the communication terminal 12 is in the failed state, printing device 10 transmits the image correction data to communication terminal 12 when communication terminal 12 creates the print data. At this time, if the state of printing device 10 is in the second energy saving mode, printing device 10 makes a state transition to the normal mode or to the first energy saving mode, before transmitting the image correction data. As a result, it becomes always possible for communication terminal 12 to create the print data based on the image correction data corresponding to the latest state of printing device 10.

Further, according to the third embodiment described above, in printing device 10, if the state of printing device 10 is in the second energy saving mode, information communication unit 202 transmits invalid image correction data to communication terminal 12. In communication terminal 12, if it is determined that the image correction data is not valid, information acquiring unit 300 sets the state of acquisition of the image correction data to a state representing a failure.

Accordingly, it becomes possible to more accurately determine whether or not the state of acquisition of the image correction data represents a success. Therefore, communication terminal 12 can more reliably acquire the image correction data corresponding to the latest state of printing device 10.

In the first to third embodiments above, the normal mode or the first energy saving mode refer to the state in which electric power is supplied to main controller 24 for executing the image correction data transmission process, while the second energy saving mode refers to a state in which electric power is not supplied to main controller 24. Thus, power consumption can further be reduced.

### Modifications

In the first to third embodiments above, printing device 10 has been described as an MFP. The present invention is not limited to such embodiments, and printing device 10 may be, for example, a printer.

Though the print data creating process and the image correction data transmission process in the third embodiment are the same as those in the second embodiment, the present invention is not limited to such an embodiment. The processes same as the first embodiment may be adopted.

In the foregoing, in the image correction data transmission process when printing device 10 is in the second energy saving mode, state management unit 200 makes a state transition of printing device 10 to the normal mode or the first energy saving mode. The present invention, however, is not limited to such an embodiment, and transition may be made only to the normal mode. Generally, state transition of printing device 10 requires time period of about 15 seconds. Therefore, as described above, at the time of creation of the print data by communication terminal 12, if the state of printing device 10 is changed beforehand to the normal mode, the printing time can be reduced when printing process is actually executed.

The embodiments as have been described here are mere examples and should not be interpreted as restrictive. The scope of the present invention is determined by each of the claims with appropriate consideration of the written description of the embodiments and embraces modifications within the meaning of, and equivalent to, the languages in the claims.

What is claimed is:

1. A print system, comprising a communication terminal performing an image correction process based on image correction data to create print data, and a printing device performing a printing process based on said print data; wherein
said communication terminal includes
an inquiry unit inquiring said printing device whether or not acquisition of said image correction data is possible, at every predetermined prescribed time interval,
a first data receiving unit receiving, if a result of determination to said inquiry indicates that acquisition of said image correction data is possible, the image correction data transmitted from said printing device,
a first setting unit setting a state of acquisition of the image correction data to a state representing a success, in response to said first data receiving unit receiving said image correction data,
an instruction receiving unit receiving an instruction requesting creation of said print data,
an acquisition state determining unit determining whether the state of acquisition of the image correction data represents a success, in response to said instruction receiving unit receiving said instruction,
a first requesting unit requesting, if it is determined by said acquisition state determining unit that the state of acquisition of the image correction data does not represent a success, said printing device to transmit said image correction data, and
a second data receiving unit receiving, in response to said request by said first requesting unit, the image correction data transmitted from said printing device; and
said printing device includes
an inquiry receiving unit receiving said inquiry made by said inquiry unit,
a first determining unit determining whether or not the state of the printing device allows transmission of the image correction data to said communication terminal, in response to said inquiry receiving unit receiving said inquiry,
a first data transmitting unit transmitting, if it is determined by said first determining unit that the state of said printing device allows transmission of the image correction data to said communication terminal, said image correction data to said communication terminal,
a first request receiving unit receiving said request from said first requesting unit,
a second determining unit determining whether or not the state of the printing device allows transmission of the image correction data to said communication terminal, in response to said first request receiving unit receiving said request,
a transition unit causing, if it is determined by said second determining unit that the state of the printing device does not allow transmission of the image correction data to said communication terminal, a state transition of the printing device to a state allowing transmission of said image correction data, and
a second data transmitting unit transmitting, if it is determined by said second determining unit that the state of the printing device allows transmission of the image correction data to said communication terminal, or if the state transition has been done by said transition unit, said image correction data to said communication terminal.

2. The print system according to claim 1, wherein
said communication terminal further includes
a commanding unit commanding, if it is determined by said acquisition state determining unit that the state of acquisition of the image correction data does not represent a success, said printing device to make a state transition to a state allowing transmission of the image correction data, before requesting said printing device to transmit said image correction data, and wherein,
after said command is given by said commanding unit, said communication terminal requests, by said first requesting unit, said printing device to transmit said image correction data; and
said printing device further includes
a command receiving unit receiving a command from said commanding unit, and wherein
said printing device determines, by said second determining unit, whether the state of the printing device allows transmission of the image correction data to said communication terminal, in response to said command receiving unit receiving said command, not in response to said first request receiving unit receiving said request, and wherein,
if it is determined by said second determining unit that the state of the printing device allows transmission of the image correction data to said communication terminal, or if the state transition has been made by said transition unit, further in response to said first request receiving unit receiving said request, said printing device transmits, by said second data transmitting unit, said image correction data to said communication terminal.

3. The print system according to claim 1, wherein
the state allowing transmission of the image correction data to said communication terminal refers to a state in which electric power is supplied to a main controller executing a process for transmitting said image correction data; and
the state not allowing transmission of the image correction data to said communication terminal refers to a state in which electric power is not supplied to said main controller.

4. The print system according to claim 1, wherein
said communication terminal further includes
a determination result receiving unit receiving a result of determination to said inquiry transmitted from said printing device, and
a second requesting unit requesting, if the result of determination to said inquiry received by said determination result receiving unit indicates that acquisition of said image correction data is possible, said printing device to transmit the image correction data;
said printing device further includes
a first result transmitting unit transmitting, if it is determined by said first determining unit that the state of the printing device allows transmission of the image correction data to said communication terminal, a piece of information indicating that acquisition of said image correction data is possible, as a result of determination to said inquiry, to said communication terminal,
a second request receiving unit receiving said request from said second requesting unit; and further wherein
said first data transmitting unit transmits, in response to said second request receiving unit receiving said request, said image correction data to said communication terminal.

5. The print system according to claim 4, wherein
said communication terminal further includes
a second setting unit setting the state of acquisition of the image correction data to a state representing a failure, if the result of determination to said inquiry received by said determination result receiving unit indicates that acquisition of said image correction data is impossible; and
said printing device further includes
a second result transmitting unit transmitting, if it is determined by said first determining unit that the state of the printing device does not allow transmission of the image correction data to said communication terminal, a piece of information indicating that acquisition of said image correction data is impossible, as a result of determination to said inquiry, to said communication terminal.

6. A print system, comprising a communication terminal performing an image correction process based on image correction data to create print data, and a printing device performing a printing process based on said print data; wherein
said communication terminal includes
a first requesting unit requesting said printing device to transmit said image correction data, at every predetermined prescribed time interval,
a first data receiving unit receiving the image correction data transmitted from said printing device in response to said request by said first requesting unit,
an analysis determining unit analyzing said image correction data received by said first data receiving unit and, based on a result of analysis, determining whether or not said image correction data is valid,
a first setting unit setting a state of acquisition of the image correction data to a state representing a success, if it is determined by said analysis determining unit that said image correction data is valid,
an instruction receiving unit receiving an instruction requesting creation of said print data,
an acquisition state determining unit determining whether the state of acquisition of the image correction data represents a success, in response to said instruction receiving unit receiving said instruction,
a commanding unit commanding said printing device to make a state transition to a state allowing transmission of the image correction data, if it is determined by said acquisition state determining unit that the state of acquisition of the image correction data does not represent a success,
a second requesting unit requesting, after said command is given from said commanding unit, said printing device to transmit said image correction data, and
a second data receiving unit receiving the image correction data transmitted from said printing device in response to said request from said second requesting unit; and further wherein
said printing device includes
a first request receiving unit receiving said request from said first requesting unit,
a first determining unit determining whether the state of the printing device allows transmission of the image correction data to said communication terminal, in response to said first request receiving unit receiving said request,
a first data transmitting unit transmitting valid image correction data to said communication terminal, if it is determined by said first determining unit that the state of the printing device allows transmission of the image correction data to said communication terminal,
a command receiving unit receiving said command from said commanding unit,
a second determining unit determining whether or not the state of the printing device allows transmission of the image correction data to said communication terminal, in response to said command receiving unit receiving said command,
a transition unit, causing a state transition of the printing device to a state allowing transmission of the image correcting data, if it is determined by said second determining unit that the state of the printing device does not allow transmission of the image correction data to said communication terminal,
a second request receiving unit receiving said request from said second requesting unit, and
a second data transmitting unit transmitting said image correction data to said communication terminal, in response to said second request receiving unit receiving said request.

7. The print system according to claim 6, wherein
said printing device further includes
a third data transmitting unit transmitting invalid image correction data to said communication terminal, if it is determined by said first determining unit that the state of the printing device does not allow transmission of the image correction data to said communication terminal; and
said communication terminal further includes
a second setting unit setting the state of acquisition of the image correction data to a state representing a failure, if it is determined by said analysis determining unit that said image correction data is not valid.

8. A communication terminal used in a print system including the communication terminal performing an image correction process based on image correction data to create print data, and a printing device performing a printing process based on said print data,
said communication terminal comprising:
an inquiry unit inquiring said printing device whether or not acquisition of said image correction data is possible, at every predetermined prescribed time interval;
a first data receiving unit receiving, if a result of determination to said inquiry transmitted from said printing device indicates that acquisition of said image correction data is possible, the image correction data transmitted from said printing device;
a first setting unit setting a state of acquisition of the image correction data to a state representing a success, in response to said first data receiving unit receiving said image correction data;
an instruction receiving unit receiving an instruction requesting creation of said print data;
an acquisition state determining unit determining whether the state of acquisition of the image correction data represents a success, in response to said instruction receiving unit receiving said instruction;
a first requesting unit requesting, if it is determined by said acquisition state determining unit that the state of acquisition of the image correction data does not represent a success, said printing device to transmit said image correction data; and
a second data receiving unit receiving, in response to said request by said first requesting unit, the image correction data transmitted from said printing device.

9. The communication terminal according to claim 8, further comprising a commanding unit commanding, if it is determined by said acquisition state determining unit that the state of acquisition of the image correction data does not represent a success, said printing device to make a state transition to a state allowing transmission of the image correction data, before requesting said printing device to transmit said image correction data; wherein
after said command is given by said commanding unit, said communication terminal requests, by said first requesting unit, said printing device to transmit said image correction data.

10. A printing device used in a print system including a communication terminal performing an image correction process based on image correction data to create print data, and the printing device performing a printing process based on said print data, said printing device comprising:
an inquiry receiving unit receiving an inquiry as to whether acquisition of said image correction data is possible, transmitted from said communication terminal at every predetermined prescribed time interval;
a first determining unit determining whether or not the state of the printing device allows transmission of the image correction data to said communication terminal, in response to said inquiry receiving unit receiving said inquiry;
a first data transmitting unit transmitting, if it is determined by said first determining unit that the state of said printing device allows transmission of the image correction data to said communication terminal, said image correction data to said communication terminal;
a first request receiving unit receiving a request for transmission of said image correction data, transmitted from said communication terminal;
a second determining unit determining whether or not the state of the printing device allows transmission of the image correction data to said communication terminal, in response to said first request receiving unit receiving said request;
a transition unit causing, if it is determined by said second determining unit that the state of the printing device does not allow transmission of the image correction data to said communication terminal, a state transition of the printing device to a state allowing transmission of said image correction data; and
a second data transmitting unit transmitting, if it is determined by said second determining unit that the state of the printing device allows transmission of the image correction data to said communication terminal, or if the state transition has been done by said transition unit, said image correction data to said communication terminal.

11. The printing device according to claim 10, further comprising a command receiving unit receiving a command causing said printing device to make a state transition to a state allowing transmission of said image correction data, transmitted from said communication terminal, before said first request receiving unit receives the request for transmission of said image correction data, transmitted from said communication terminal; wherein
said second determining unit determines whether or not the state of said printing device allows transmission of the image correction data to said communication terminal, in response to said command receiving unit receiving said command, not in response to said first request receiving unit receiving said request; and
said second data transmitting unit transmits said image correction data to said communication terminal, if it is determined by said second determining unit that the state of said printing device allows transmission of the image correction data to said communication terminal, or if the state transition is made by said transition unit, further in response to said first request receiving unit receiving said request.

12. A communication terminal used in a print system including the communication terminal performing an image correction process based on image correction data to create print data, and a printing device performing a printing process based on said print data,
said communication terminal comprising:
a first requesting unit requesting said printing device to transmit said image correction data, at every predetermined prescribed time interval;
a first data receiving unit receiving the image correction data transmitted from said printing device, in response to said request from said first requesting unit;
an analysis determining unit analyzing said image correction data received by said first data receiving unit, and determining whether or not said image correction data is valid based on a result of analysis;
a first setting unit setting a state of acquisition of the image correction data to a state representing a success, if it is determined by said analysis determining unit that said image correction data is valid;
an instruction receiving unit receiving an instruction requesting creation of said print data;
an acquisition state determining unit determining whether or not the state of acquisition of the image correction data represents a success, in response to said instruction receiving unit receiving said instruction;
a commanding unit commanding said printing device to make a state transition to a state allowing transmission of the image correction data, if it is determined by said acquisition state determining unit that the state of acquisition of the image correction data does not represent a success;
a second requesting unit requesting said printing device to transmit said image correction data after said command is given by said commanding unit; and
a second data receiving unit receiving the image correction data transmitted from said printing device in response to said request from said second requesting unit.

13. A printing device used in a print system including a communication terminal performing an image correction process based on image correction data to create print data, and the printing device performing a printing process based on said print data, said printing device comprising:
a first request receiving unit receiving a request for transmission of said image correction data, transmitted from said communication terminal at every predetermined prescribed time interval;
a first determining unit determining whether or not the state of said printing device allows transmission of the image correction data to said communication terminal, in response to said first request receiving unit receiving said request;
a first data transmitting unit transmitting valid image correction data to said communication terminal, if it is determined by said first determining unit that the state of said printing device allows transmission of the image correction data;
a command receiving unit receiving a command to make a state transition of said printing device to a state allowing transmission of the image correction data, transmitted from said communication terminal;
a second determining unit determining whether or not the state of said printing device allows transmission of the image correction data to said communication terminal, in response to said command receiving unit receiving said command;
a transition unit causing a state transition of the printing device to the state allowing transmission of the image correction data, if it is determined by said second determining unit that the state of the printing device does not allow transmission of the image correction data to said communication terminal;
a second request receiving unit receiving a request for transmission of said image correction data, transmitted from said communication terminal after said command is given; and
a second data transmitting unit transmitting said image correction data to said communication terminal, in response to said second request receiving unit receiving said request.
